(19) United States
(12) Patent Application Publication
(10) Pub. No.: US 2018/0243967 A1
(43) Pub. Date: Aug. 30, 2018

(54) BALLISTIC PLATE MATERIALS AND METHOD

(71) Applicant: Mystery Ranch, Ltd., Bozeman, MT (US)

(72) Inventors: Jim Curtin, Pittsford, NY (US); Tanner Paul Miller, Bozeman, MT (US); Katelyn Kalberer, Bellevue, WA (US); Kent D. Saucedo, Mesa, AZ (US)

(21) Appl. No.: 15/876,021

(22) Filed: Jan. 19, 2018

Related U.S. Application Data
(63) Continuation-in-part of application No. 14/267,858, filed on May 1, 2014, now abandoned.
(60) Provisional application No. 61/885,354, filed on Oct. 1, 2013.
(60) Provisional application No. 61/818,352, filed on May 1, 2013.

(51) Int. Cl. B29C 51/14; B29C 51/10; B29C 51/30; B29C 51/42

(52) U.S. Cl. CPC B29C 51/14; B29C 51/10; F41H 5/0435; B29C 51/424; B29C 51/30

(57) ABSTRACT

An armor production tool including a housing having at least two housing portions that form a substantially air-tight chamber when closed. The tool can include a lower thermal diaphragm forming at least a portion of a mold, and an upper thermal diaphragm forming at least a portion of the mold and capable of engaging the lower flexible membrane. The thermal diaphragms may comprise a thermal transfer membrane, a pressure bearing membrane and a fluid dispersion layer between the thermal transfer membrane and the pressure bearing member. A heating or cooling fluid can be circulated through the fluid dispersion layer to apply heat or to cool the armor part during the molding process. The tool can include a pressure port for pressurizing the chamber and to move the thermal diaphragm towards each other to apply compression on the molded armor part, and a locking mechanism for locking the two housing portions.

### CROSS REFERENCE TO RELATED APPLICATIONS

This application is a continuation-in-part of U.S. patent application Ser. No. 14/267,858 titled “BALLISTIC PLATE MATERIALS AND METHOD” filed on May 1, 2014, which claims the benefit of filing date of U.S. Provisional Application Ser. No. 61/818,352 titled “BODY ARMOR MATERIALS AND METHOD” filed on May 1, 2013, and U.S. Provisional Application Ser. No. 61/885,354 titled “BALLISTIC PLATE MATERIALS AND METHOD” filed on Oct. 1, 2013, the specifications of which are each incorporated by reference herein in their entirety.

### BACKGROUND

Body armor is generally shaped to fit snugly onto a user so as to provide the maximum protection while maintaining an acceptable range of motion. Body armor is fabricated of numerous layers, each of which provides a specific function. For example, some layers can include an energy absorbing layer, a penetration resistant layer, a reinforcing layer, an impact absorbing layer, or a fragmentation minimizing layer. Most of the layers are generally flexible, and capable of being laminated onto a substantially planar or non-planar surface. However, where the armor for human body use includes one or more ceramic strike-face layers, the layer can be non-planar, and substantially rigid and non-compliant.

In most body armor systems, each successive functional flexible layer is generally bonded to a non-planar ceramic strike-face using resins that require heat and pressure. Oftentimes, each successive functional layer is bonded sequentially, one layer at a time. To reduce fabrication complexity and cycle time, a need exists for a technology that enables the fabrication of body armor, particularly non-planar armor used in on-body applications, where all functional layers of the armor are bonded and cured in one step.

### SUMMARY

Some embodiments of the invention include an armor production tool comprising a housing including at least two housing portions which form a substantially air-tight chamber when closed. In some embodiments, the tool can comprise a lower flexible membrane dimensioned to fit within the housing and form at least a portion of a mold, and an upper flexible membrane dimensioned to fit within the housing and engage the lower flexible membrane to thereby form another portion of the mold. Further, the tool can comprise at least one pressure port for insertion of pressurizing fluid to pressurize the chamber and move portions of the mold towards each other, and a locking mechanism for locking the two housing portions together.

In some embodiments, the armor production tool includes a pressurizable lower chamber defined by the lower flexible membrane and a portion of the housing. In some further embodiments, the upper flexible membrane and a portion of the housing can define an upper chamber that can be pressurized.

Some embodiments include an armor production tool claimed where the upper flexible membrane and a portion of the housing define an upper chamber that can be pressurized, and the lower flexible membrane and a portion of the housing define a lower chamber that can be pressurized substantially simultaneously with the upper chamber by the at least one pressure port. In some further embodiments, the upper and lower chambers can be depressurized substantially simultaneously by the at least one pressure port. In some other embodiments, the upper flexible membrane and a portion of the housing define an upper chamber that can be pressurized, and the lower flexible membrane and a portion of the housing define a lower chamber that can be pressurized substantially independently from the upper chamber.

Some embodiments of the invention include a method of producing armor comprising providing a housing including at least two housing portions which form a substantially air-tight chamber when closed. The method includes forming a portion of a mold with a lower flexible membrane dimensioned to fit within the housing, forming another portion of the mold with an upper flexible membrane dimensioned to fit within the housing, and inserting at least one layer of a composite material to be molded between a portion of the lower flexible membrane and a portion of the upper flexible membrane. The method also includes closing and locking the housing portions together to form the substantially air-tight chamber, and adding pressurized fluid to pressurize the chamber and move portions of the mold towards each other.

In some embodiments of the method, the lower flexible membrane and a portion of the housing define a lower chamber that can be pressurized. In some further embodiments of the method, the upper flexible membrane and a portion of the housing define an upper chamber that can be pressurized. In some other embodiments of the method, the upper flexible membrane and a portion of the housing define an upper chamber that can be pressurized, and the lower flexible membrane and a portion of the housing define a lower chamber that can be pressurized substantially simultaneously with the upper chamber by the at least one pressure port.

Some embodiments of the method further include the step of depressurizing the upper and lower chambers substantially simultaneously using the at least one pressure port. In some other embodiments, the method further includes pressurizing an upper chamber defined by the upper flexible membrane and a portion of the housing, and pressurizing, substantially independently from the upper chamber, a lower chamber defined by the lower flexible membrane and a portion of the housing. In some embodiments of the method, the composite material is inserted into a preform cavity defined by the upper and lower flexible membranes.

In some embodiments of the method, the composite material comprises at least one of a polymer comprising aramids (aromatic polyamides), poly(m-xylylene adipamide), poly(p-xylylene sebacamide), poly (2,2,2-trimethyl-hexamethylene terephthalamide), poly(piperazine sebacamide), poly(metaphenylene isophthalamide) (Nomex) and poly(p-phenylene terephthalamide), aliphatic and cycloaliphatic polyamides, including the copolyamide of 30% hexamethylene diammonium isophthalate and 70% hexamethylene diammonium adipate, the copolyamide of up to 30% bis-(-amidocyclohexyl) methylene, terephthalic acid and caprolactam, polyhexamethylene adipamide, poly(butyrolactam), poly(-aminonanoic acid), poly(enantholactam), poly(caprillactam), polycaprolactam, poly(p-phenylene terephthalamide), polyhexamethylene sebacamide, polyaminoundecanamide, polydodecanolacatam, polyhexamethylene isophthalamide, polyhexamethylene terephthal amide, polycaproamide, poly(nonamethylene azelamide), poly(decamethylene azelamide), poly(decamethylenesebacamide), poly[bis-4-aminocyclohexyl) methane 1,10-decanedi-carboxamide](Qiana)(trans), and aliphatic, cycloaliphatic and aromatic polyesters including poly(1,4-cyclohexylidene dimethyl eneterephthalate) cis and trans, poly(ethylene-2,6-naphthalate), poly(1,4-cyclohexane dimethylene terephthalate) (trans), poly(decamethylene terephthalate, poly(ethylene terephthalate), poly(ethylene isophthalate), poly(ethylene oxybenzoate), poly(para-hydroxy benzoate), poly(beta,beta dimethylpropiolactone), poly(decamethylene adipate), or poly(ethylene succinate).

In some other embodiments of the method, the composite material comprises at least one polymer formed of extended chain polymers by the reaction of beta-unsaturated monomers of the formula RIR2-C═CH2, where RI and R2 are either identical or different, and are hydrogen, hydroxyl, halogen, alkylcarbonyl, carboxy, alkoyxycarbonyl, heterocycle or alkyl or aryl, where the alkyl or aryl can be substituted with one or more substituents including alkoxy, cyano, hydroxyl, akyl or aryl, and extended chain polymers including polystyrene, polyethylene, polypropylene, poly(1-octadecene), polyisobutylene, poly(1-pentene), poly(2-methylstyrene), poly(4-methylstyrene), poly(1-hexene), poly(1-pentene), poly(4-methoxy styrene), poly(5-methyl-1-hexene), poly(4-methylpentene), poly(1-butene), poly(3-methyl-1-butene), poly(3-phenyl-1-propene), polyvinyl chloride, polybutylene, polyacrylonitrile, poly(methyl pentene-1), poly(vinyl alcohol), poly(vinyl-acetate), poly(vinyl butyral), poly(vinyl chloride), poly(vinylidene chloride), vinyl chloride-vinyl acetate chloride copolymer, poly(vinylidene fluoride), poly(methyl acrylate, poly(methylmethacrylate), poly(methacrylonitrile), poly(acrylamide), poly(vinyl fluoride), poly(vinyl formal), poly(3-methyl-1-butene), poly(1-pentene), poly(4-methyl-1-butene), poly(1-pentene), poly(4-methyl-1-pentene), poly(1-hexane), poly(5-methyl-1-hexene), poly(1-octadecene), poly(vinyl cyclopentane), poly(vinylcyclohexane), poly(a-vinylnaphthalene), poly(vinyl methyl ether), poly(vinylethylether), poly(vinyl propylether), poly(vinyl carbazole), poly(vinyl pyrrolidone), poly(2-chlorostyrene), poly(4-chlorostyrene), poly(vinyl formate), poly(vinyl butyl ether), poly(vinyl octyl ether), poly(vinyl methyl ketone), poly(methylisopropenyl ketone), or poly(4-phenyl styrene).

In some further embodiments of the method, a ceramic armor plate is inserted into a preform cavity defined by the upper and lower flexible membranes, and resin and flexible armor materials are layered onto the ceramic body plate, and the plate substantially defines the shape of resulting armor throughout at least the majority of the molding process.

Some embodiments of the invention include a molded armor composite comprising at least one strike-face layer, a plate cover layer, a back cover layer, and at least one backing layer, where each of the layers is configured and arranged to be bonded together by resin and molded together in one molding step. In some further embodiments, at least one backing layer includes a plurality of layers. In some other embodiments, at least one backing layer comprises at least one of a strike-face layer, a strike-face reinforcement layer, a catchment layer, and a back-face reduction layer. In other embodiments, at least one of the plate cover layer and the back cover layer comprises a ballistic layer.

The present invention also includes another embodiment of molding tool used to mold the composite armor. The molding tool may include an outer housing that is comprised of a tool upper and a tool lower that when closed define a molding chamber. In one embodiment, tool upper and tool lower are pivotally connected by a hinge. In another embodiment, tool upper and tool lower are moveable between an open position for loading raw materials and unloading the molded product, and a closed position wherein the upper tool and lower tool form the enclosed molding chamber. One of the upper tool or lower tool may be moveable on a frame or other mechanism to the positions described above. The tool upper and tool lower each include a pressure chamber which is separated from the molding chamber by a membrane or a thermal diaphragm. When a pressurized fluid is introduced into the pressure chamber, a pressure force is applied to the thermal diaphragm from the pressure chamber into the molding chamber.

The thermal diaphragm may include a fluid dispersion layer sandwiched between a thermal transfer membrane on the mold chamber side and a pressure bearing membrane on the pressure chamber side. During operation, a heated or cooled fluid can be circulated through the fluid dispersion layer between an inlet and an outlet and heated or cooled fluid can be passed through the thermal transfer membrane to heat or cool the part as it is being molded. The thermal transfer membrane and the pressure bearing membrane may be flexible and may also have elastic properties to conform to the shape of the composite armor part when pressure is applied. The fluid dispersion layer may include a media disposed therein which is a mesh-like or porous material that may be flexible and may also have elasticity. The fluid dispersion media may have a compressive strength that is greater than the pressure to be applied to the during the molding process so that the fluid dispersion layer does not collapse under the pressure applied from the pressure chamber, and allows the heating or cooling fluid to freely circulate through the fluid dispersion layer when pressure is applied. The structure of this embodiment allows for the heated or cooled fluid to be separated from the pressurized fluid and, thereby makes operation of the molding tool safer.

In operation, the layers of a composite molded armor part are placed into the molding chamber and the tool upper and the tool lower are closed and secured in the closed position. Pressurized fluid is introduced into the pressure chamber through an inlet and heated or cooled fluid is introduced into the fluid dispersion layer through an inlet. The molded armor part may be compressed and heated to either cure a resin used or to thermally bond a plurality of layers together to form a resin free composite. The pressure is applied and the heating/cooling fluid is circulated for the desired curing and/or pressing time period to result in a completed molded armor part or composite. Finally, the pressure is released through the pressurized fluid being removed from the pressure chamber through an outlet or the inlet, and the flow of fluid through the fluid dispersion layer may be stopped. Cooling fluid may be circulated through the fluid dispersion layer to cool the part if desired. The tool upper and the tool lower are separated to expose the mold chamber and the molded armor part can be removed. The application of pressure and heating/cooling fluid circulation may be controlled to operate together or may be independently operated or controlled. Moreover, the operation and application of pressure and/or circulation of the heating/cooling fluid may be the same in the tool upper and tool lower or may be independently controlled in the tool upper and tool lower.

Other aspects and advantages of the present invention will be apparent from the following detailed description of the preferred embodiments and the accompanying drawing figures.

### DESCRIPTION OF THE DRAWINGS

The accompanying drawings form a part of the specification and are to be read in conjunction therewith, in which like reference numerals are employed to indicate like or similar parts in the various views, and wherein:

FIG. 1 illustrates a perspective view of a cross section of body armor composite according to one embodiment of the invention.

FIG. 2 illustrates a perspective view of a ceramic strike-face according to one embodiment of the invention.

FIG. 3 illustrates a process to form a mold preform according to one embodiment of the invention.

FIG. 4A illustrates a perspective view of a top-side concrete mold preform according to one embodiment of the invention.

FIG. 4B illustrates a perspective view of a bottom-side concrete mold preform according to one embodiment of the invention.

FIG. 5 illustrates a process to form body armor composite according to one embodiment of the invention.

FIG. 6 illustrates method of manufacture of body armor composite depicting a plurality of layers sequentially stacked on bottom concrete mold form according to one embodiment of the invention.

FIG. 7 illustrates a method of manufacture of body armor composite depicting a plurality of layers sequentially between a bottom concrete mold form and a top bottom concrete mold form according to one embodiment of the invention.

FIG. 8 illustrates a press assembly used in a method of manufacture showing body armor composite positioned in the press according to one embodiment of the invention.

FIG. 9 illustrates body armor composite within bottom and top concrete molds following compression forming in the press assembly of FIG. 8 according to one embodiment of the invention.

FIG. 10 illustrates body armor composite following release from bottom and top concrete molds according to one embodiment of the invention.

FIG. 11 illustrates a process to form body armor composite according to another embodiment of the invention.

FIG. 12A illustrates a perspective view of a flexible mold tool in accordance with one embodiment of the invention.

FIG. 12B illustrates a cross-sectional view of the flexible mold tool depicted in FIG. 12A in accordance with one embodiment of the invention.

FIG. 12C-E illustrates perspective views of the flexible mold tool depicted in FIG. 12A in accordance with at least one embodiment of the invention.

FIG. 13 illustrates at least one layer of body armor composite including an enhanced protection region according to one embodiment of the invention.

FIG. 14 illustrates an expanded layer view of a plurality of layers of body armor composite in accordance with one embodiment of the invention.

FIG. 15A illustrates views of body armor composite including covers in accordance with one embodiment of the invention.

FIG. 15B illustrates views of body armor composite including covers in accordance with one embodiment of the invention.

FIG. 16A illustrates a front view of body armor composite after ballistic round penetration in accordance with one embodiment of the invention.

FIG. 16B illustrates a cross-sectional view of body armor composite after ballistic round penetration in accordance with one embodiment of the invention.

FIG. 16C illustrates a side view of body armor composite after multiple ballistic round penetrations in accordance with one embodiment of the invention.

FIG. 17 illustrates views of a prior art body armor composite after ballistic round penetration in accordance with one embodiment of the invention.

FIG. 18 illustrates a perspective view of a helicopter blade fabricated using the method of FIG. 11 in accordance with one embodiment of the invention.

FIG. 19 is a perspective view of one embodiment of a molding tool of the present invention.

FIG. 20 is a sectional view of the embodiment of the molding tool of FIG. 19 cut along the line 20-20.

FIG. 21 is a blown-up section of a portion of the sectional view of FIG. 20 showing the thermal diaphragm subassembly.

FIG. 22 is a sectional view of the embodiment of the molding tool of FIG. 19 cut along the line 20-20 showing the pressurized fluid inlet.

FIG. 23 is a sectional view of the molding tool of FIG. 22 cut along the line 23-23.

FIG. 24 is a sectional view of the embodiment of the molding tool of FIG. 19 cut along the line 20-20 showing a molded composite armor part being molded.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

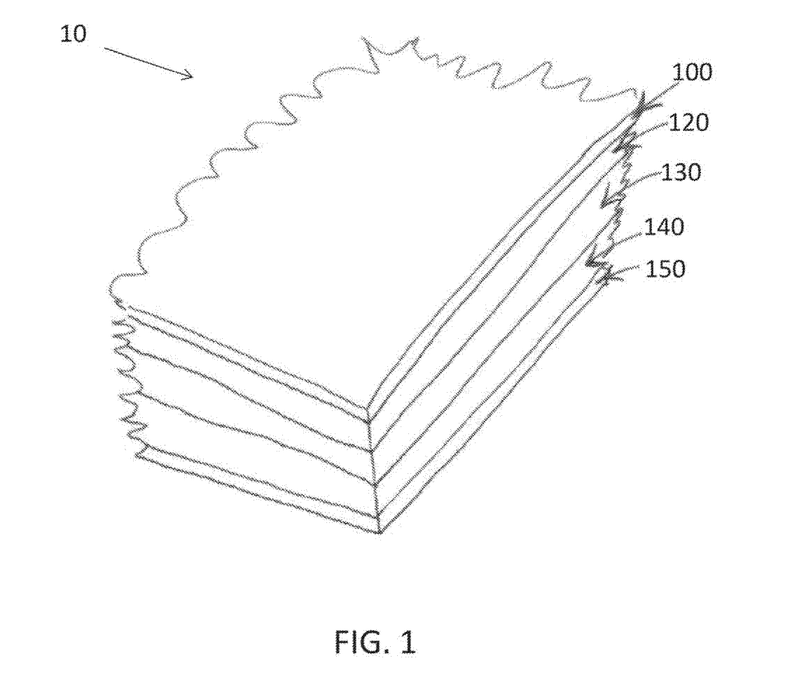

Some embodiments of the invention include a body armor composite structure material, and apparatus and methods of fabrication. Some embodiments include a body armor composite structure material that can include stacking a plurality of layers of one or more different materials and bonding the materials to form a substantially monolithic composite article that can function as body armor. For example, as shown FIG. 1 illustrating a perspective cross-sectional view of a cross section of body armor composite 10, some embodiments can include a plurality of coupled layers. In some embodiments, the body armor composite 10 can include one or more back-face reduction layers 150 that can be provided over at least one strike-face layer 120, and/or at least one strike-face reinforcement layer 130, and/or at least one catchment layer 140.

For example, in some embodiments, a back-face reduction layer 150 can be coupled to the catchment layer 140. In some embodiments, an outer layer covering at least a strike-face or front impact receiving side of the body armor composite 10 (the at least one strike-face layer 120) can include a bump guard 100. In some embodiments, the bump guard 100 can include a spacer fabric, or can include polymeric foam. In some embodiments, the desired shape of the armor is defined at least by the strike-face layer 120, and any other layers can be shaped to substantially the same shape as the strike-face layer 120.

In the example embodiments shown in FIG. 1, the body armor composite 10 can include at least one back-face reduction layer 150 to at least partially reduce blunt force trauma. In some embodiments, the one or more back-face reduction layers 150 can comprise woven polyester or other related polymeric fiber materials. In some embodiments, the one or more back-face reduction layers 150 can include various thicknesses, thread weights and densities. Further, in addition to protecting against trauma, in some embodiments, the body armor composite 10 can include one or more back-face reduction layers 150 that can protect against random residual shrapnel penetration.

In some further embodiments, the body armor composite 10 can include at least one wicking layer (not shown). In some embodiments, at least one wicking layer can be configured and arranged to substantially transport perspiration away from a user's body. For example, in some embodiments, at least one wicking layer can be coupled to an external surface of the body armor composite 10 (i.e., either to a bump guard layer 100 and/or the one or more back-face reduction layers 150). In this instance, the at least one wicking layer can be configured and arranged to contact at least one surface of a user.

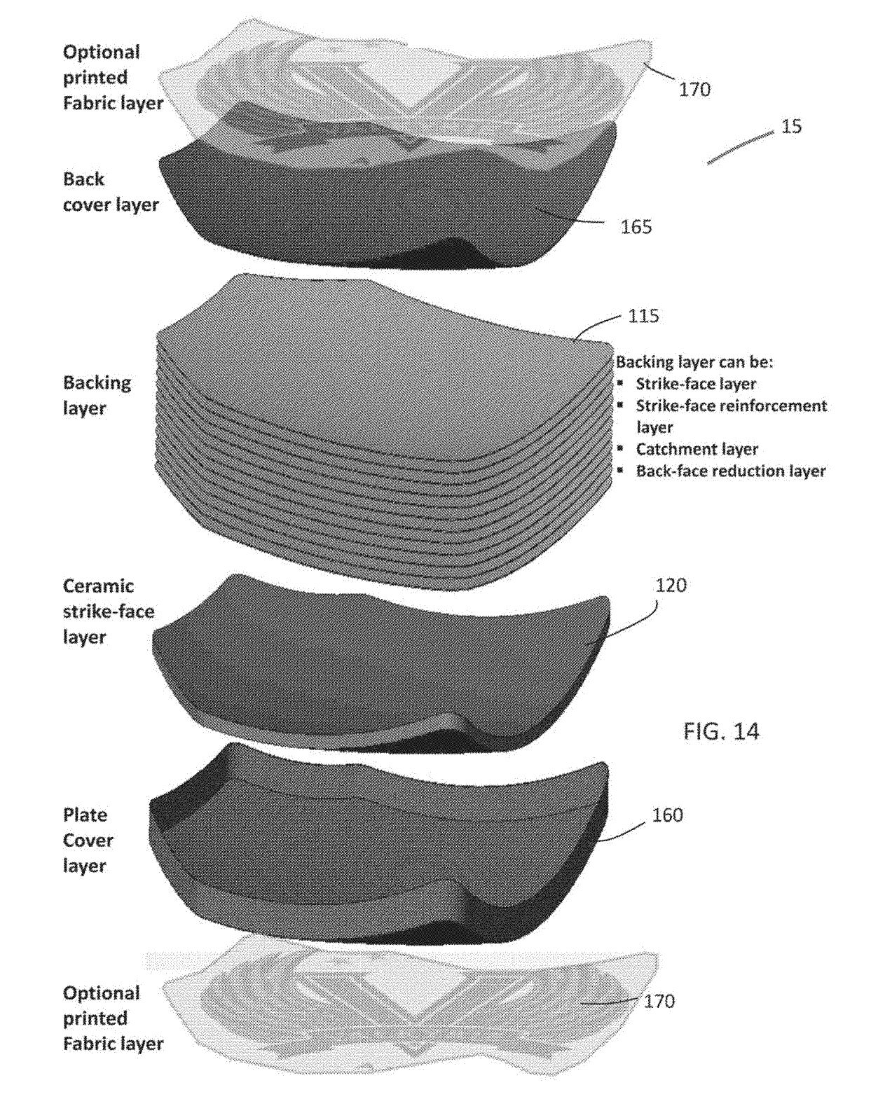

In some further embodiments, the body armor composite 10 can include more or less layers and/or arrangements of layers than those shown in FIG. 1. For example, in some embodiments, the body armor composite 10 can comprise a plurality of layers forming body armor composite 15 (illustrated in the exploded view shown in FIG. 14 and described below).

In some embodiments, the body armor composite 10, 15 can include at least one strike-face 120. In some embodiments, the strike-face 120 can comprise a ceramic material. In some embodiments, the strike-face 120 can be a substantially flat or substantially planar.

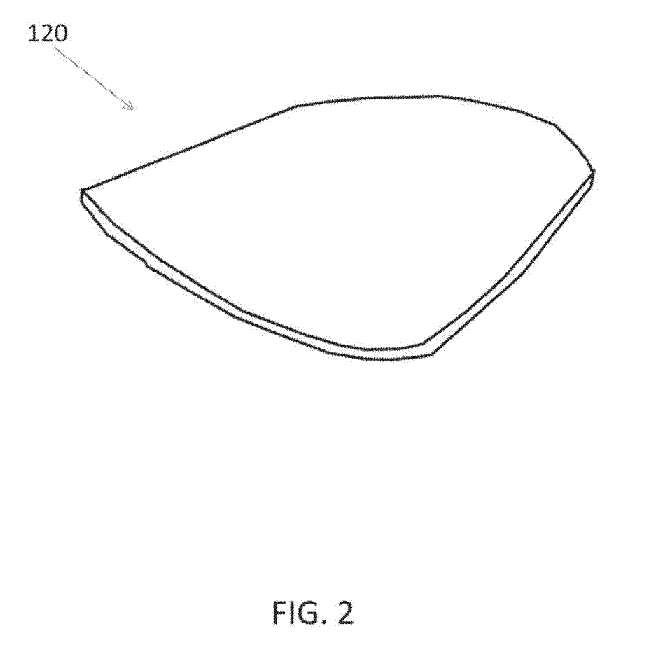

In some other embodiments, particularly those designed to be used as human body armor, the strike-face 120 can include substantially non-planar portions. For example, FIG. 2 shows a perspective view of a strike-face 120 according to one embodiment of the invention. In this example, the strike-face 120 is shown to be substantially curved (e.g., to generally cover the abdomen of a human). In some embodiments, one or more of the surfaces and/or one or more regions of the body armor composite 10, 15 can comprise a surface with a varying angle of curvature over one or more regions of the body armor 10, 15. For example, in embodiments designed for the abdomen and thorax of a human, at least a portion of the body armor composite 10, 15 can include a substantially non-planar region designed to at least partially cover the breast region of a male or female subject. Unlike conventional technologies, some embodiments of the invention enable steeply sloped curved sections of body armor to be readily fabricated, enabling customized fitments for varying physiques while providing excellent structural properties.

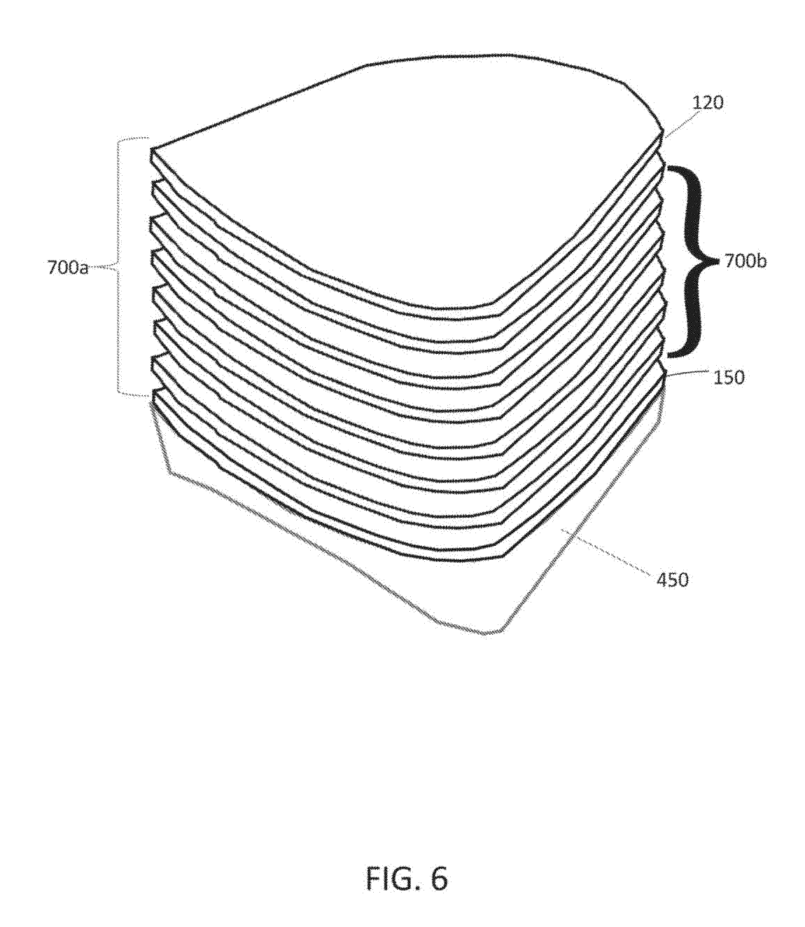

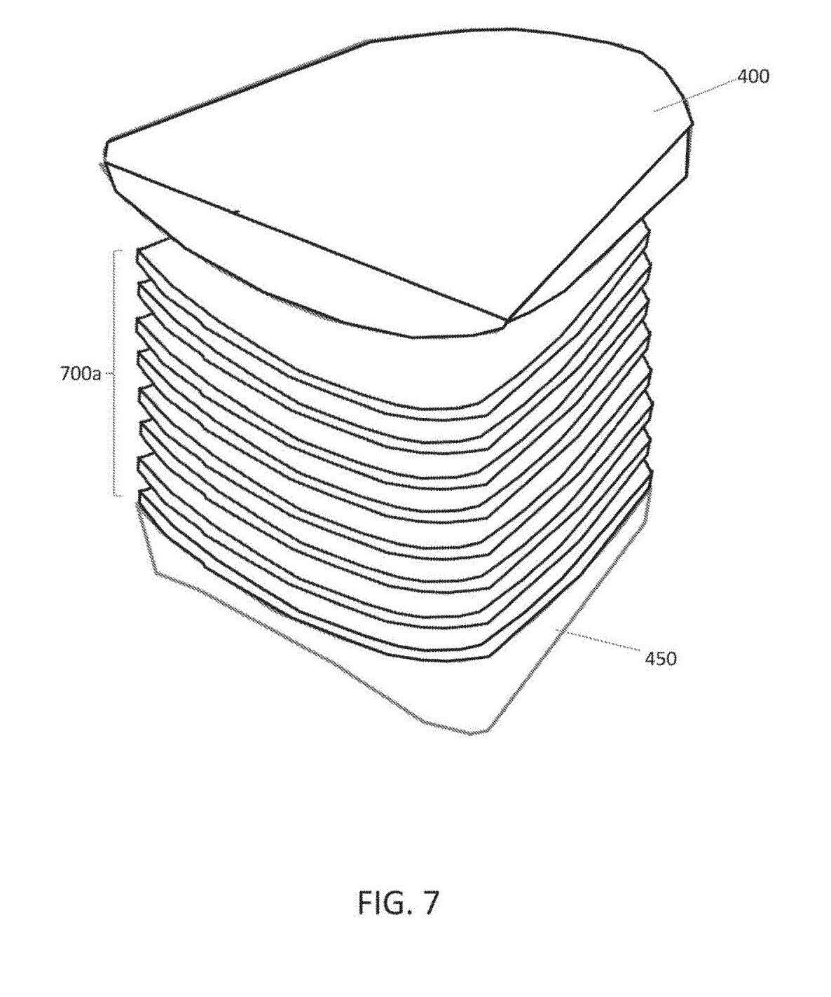

In some embodiments, in order to enable forming and manufacture of the body armor composite 10, 15 with one or more layers and/or portions of the body armor composite 10, 15 that can be substantially non-planar, some embodiments include a process that can include at least one manufacturing step where pre-formed layers (e.g., layers 700a positioned on preform 450 shown in FIG. 6, and layers 700a positioned between preforms 400, 450 in FIG. 7) are compressed. A mold tool can transfer pressure equi-axially to the surface of the pre-formed layers 700a while maintaining the shape and preventing mechanical stressing of the ceramic strike-face 120 (that can be at least one of the layers 700a). To accomplish these results, some embodiments of the invention can include methods of fabricating a bottom mold preform 450 and a top mold preform 400 for use in laminating the layers 700a. In this instance, the bottom mold preform 450 can be configured and arranged to transfer pressure to one side of a plurality of layers 700a, and the top mold preform 400 can be configured and arranged to substantially simultaneously apply pressure to the other side of the plurality of layers 700a.

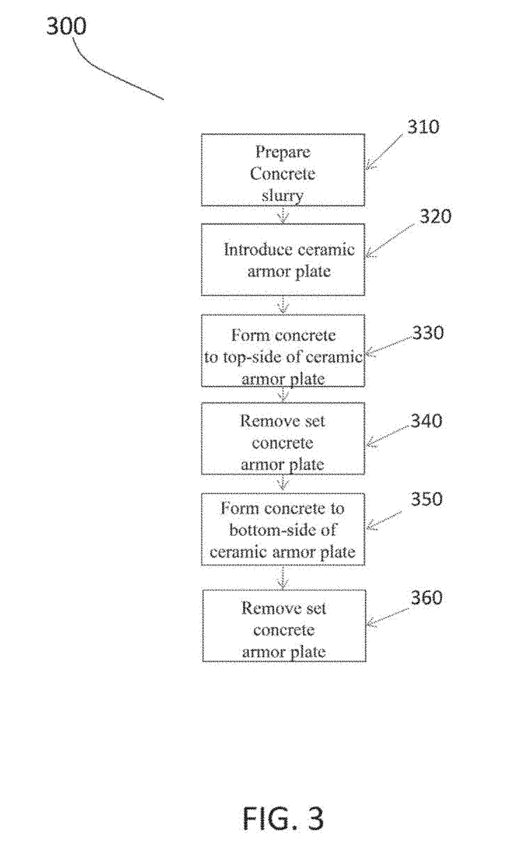

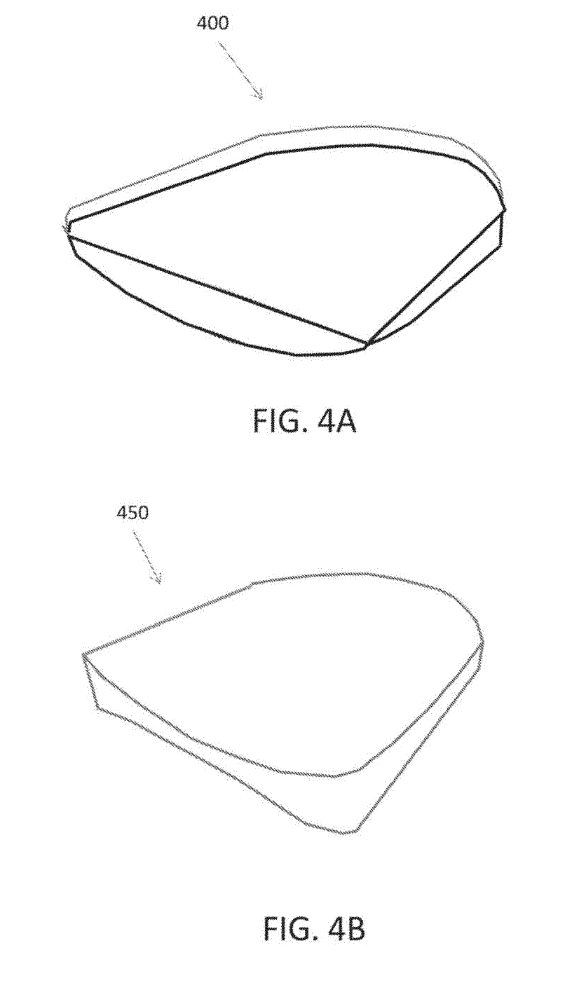

FIG. 3 illustrates a process 300 to form the aforementioned mold preforms 400, 450 according to one embodiment of the invention. Following preparation of concrete slurry 310, a strike-face 120 can be positioned and concrete slurry formed onto one side of the strike-face 120. Once the concrete has hardened, a concrete mold preform can be separated (step 340) from the strike-face 120, and process steps 350, 360 can be used to form a concrete preform matched to the opposite side of the strike-face 120. Completion of process 300 can result in two concrete preforms, including a top-side concrete preform 400 (shown in FIG. 4A), and a bottom-side concrete preform 450 (as shown in FIG. 4B).

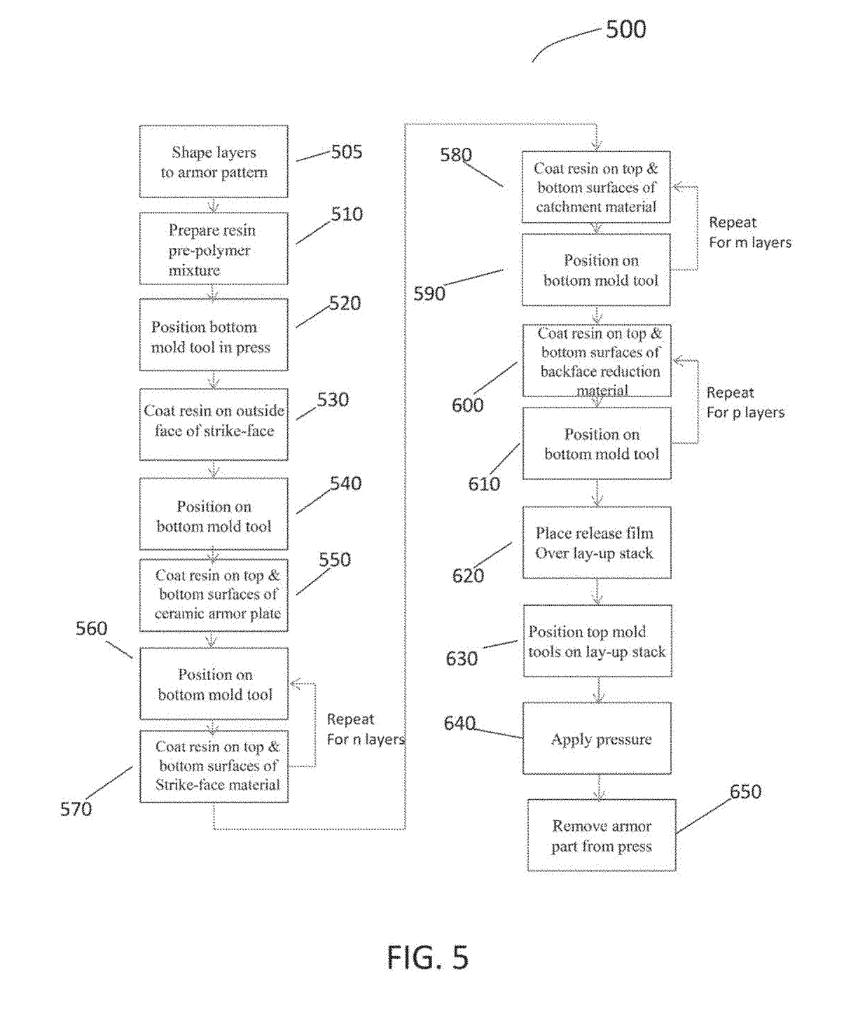

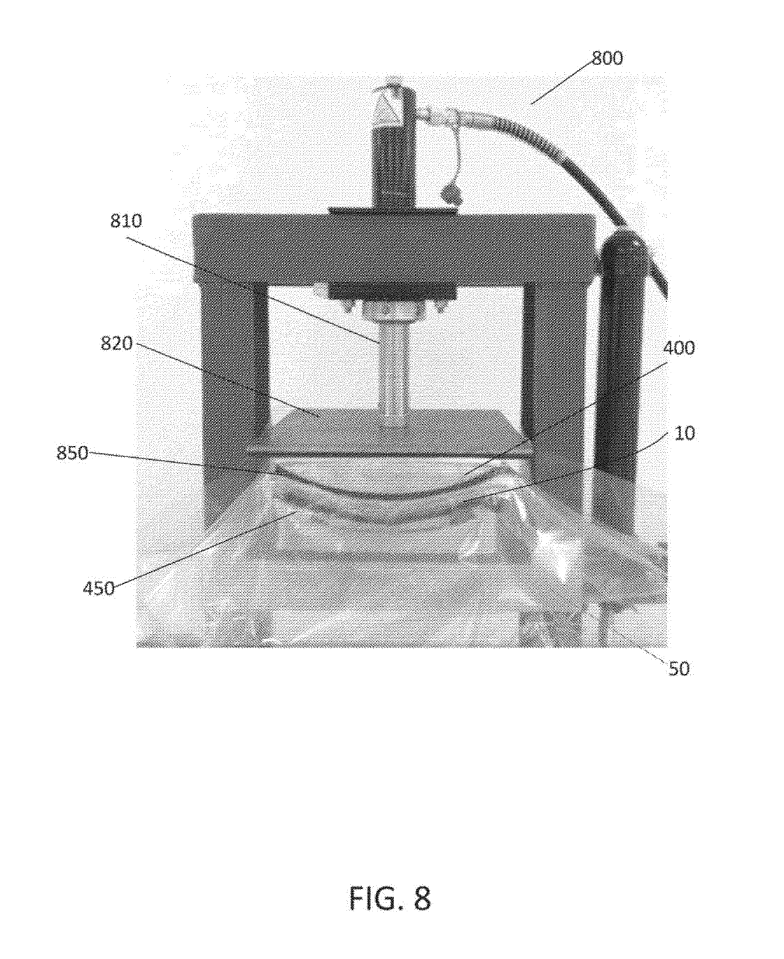

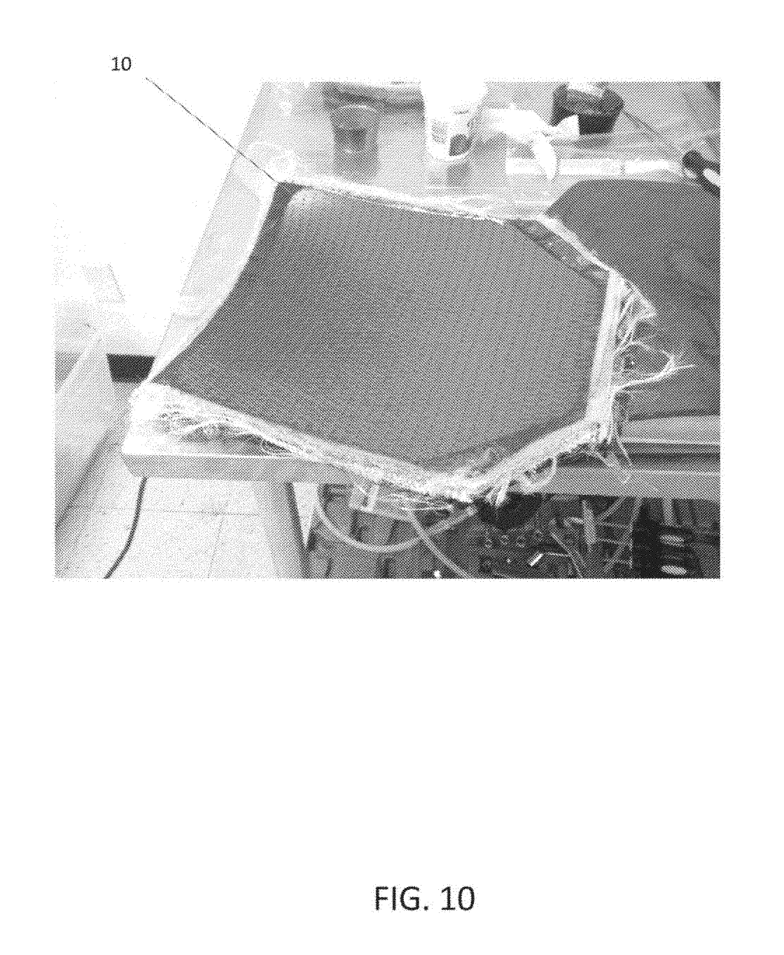

Some embodiments of the invention include methods of forming body armor composite structures utilizing the preforms 400, 450 formed by the methods described earlier. For example, in some embodiments, body armor composite 10 as shown in FIG. 10 can be formed using a process 500 shown in FIG. 5, using a press assembly 800 shown in FIG. 8. As shown in FIG. 5, a process 500 of fabricating body armor composite 10 can include a sequence of steps that utilize the aforementioned mold preforms 400 and 450.

In some embodiments, the process 500 can include trimming and shaping the plurality of layers 700a that are initially formed in step 505 to a desired armor shape (e.g. to fit the strike-face 120). In some alternative embodiments, one or more of the layers 700a can be trimmed to a desired shape once the composite lay-up (e.g., 850 in FIG. 8) has been assembled and laminated. In some embodiments, following preparation of a pre-polymer resin in step 510, bottom-side concrete pre-form 450 can be positioned in step 520. In some embodiments, the outside face of the strike-face 120 can be coated with resin (step 530) and positioned on the pre-form 450 (step 540). In some embodiments, one or more resins can be applied to the strike-face 120. In some embodiments, the one or more of the resins can be roll-coated or brushed. In other embodiments, resin can be kinetically sprayed or electrostatically sprayed. In some further embodiments, dip-coating can be used, the resin can be spin-coated, and/or the resin can be screen-printed.

In some embodiments, resin can be applied to both top and bottom surfaces of the strike-face 120 (step 550), and the strike-face 120 can be positioned onto the preform 450 (shown as step 560). In some further embodiments, resin can be applied to the top and bottom surfaces of a strike-face reinforcement material 130 (shown as step 570), and steps 560, 570 can be repeated based on the desired number of layers of strike-face reinforcement material 130. Further, in some embodiments, resin can be applied to both top and bottom surfaces of the catchment layer 140 (shown as step 580), which can subsequently be positioned onto the preform 450 (shown as step 590). Steps 580, 590 can be repeated based on the desired number of layers of catchment layer 140. In some embodiments, resin can be applied to the bottom surfaces of the back-face reduction material 150 (shown as step 600), which can subsequently be positioned onto the preform 450 (shown as step 610, and illustrated in FIG. 6 showing an exploded view of layers 700a positioned on the preform 450). In some embodiments, steps 600, 610 can be repeated based on the desired number of layers of back-face material 150.

In some embodiments, a release film 50 can be laid into (or otherwise applied to) the surface of the stack in step 620, and the preform 400 can be positioned on the stack (illustrated in FIG. 7 showing an exploded view of layers 700a positioned on the preform 450 and with preform 400 positioned on the layers 700a). Further, the process 500 can include applying pressure (e.g., using the press assembly 800 as shown in FIG. 8). In some embodiments, a pressure of 12 psi or greater can be applied. In some embodiments, resin gelation occurs within 15 minutes and full cure is reached within 1 hour. In some embodiments, following completion of the lamination stage, pressure can be released from ram 810 of the press assembly 800, and the body armor composite 10 can be removed.

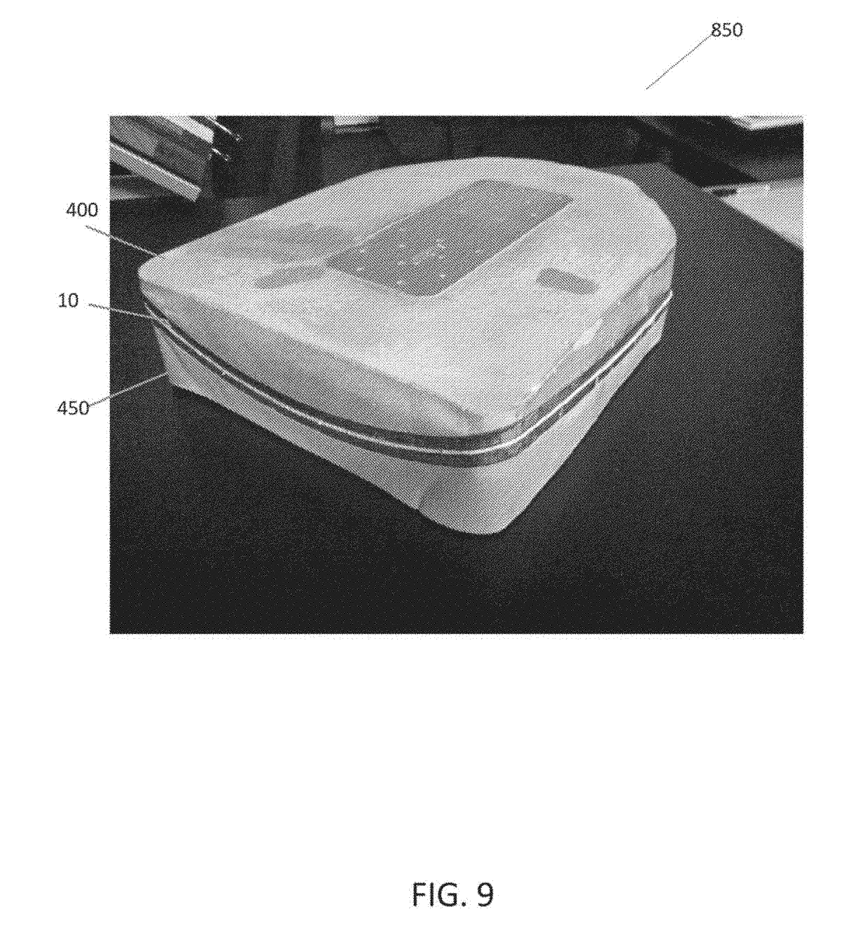

FIG. 9 illustrates an assembly 850 comprising a body armor composite 10 within bottom and top concrete molds (bottom-side preform 450 and the top-side preform 400) following compression forming in the press assembly 800 of FIG. 8 using the process 500. FIG. 10 illustrates body armor composite 10 following release from the preforms 400, 450 of the assembly 850 according to one embodiment of the invention. As shown in FIG. 8, the previously described release film 50 is positioned at the interfaces between the body armor composite 10 in the assembly 850, and the surfaces of the bottom-side preform 450 and the top-side preform 400. The film 50 facilities ease of release of the body armor composite 10 from the preforms 400,450 in the assembly 850 following lamination. In some embodiments, method 500 can be performed sequentially in a single-batch, and in other embodiments, the steps of 500 can be performed sequentially and in parallel with other steps of method 500. In some embodiments, the method 500 is continuous.

In some embodiments, body armor composite 10, 15 and a wide range of other products can be formed using a method 500 shown in FIG. 5 using various flexible mold tools. For example, in some embodiments, substantially uniform pressure can be applied to a surface using a conventional gel-pack or a conventional silicone mold. In some embodiments for example, steps in the process 500 that utilize one or more of the mold preforms 400, 450 can be substituted by at least one gel-pack and/or silicone mold tool. In this instance, a conventional gel-pack or silicone mold tool can be attached to a plate 820 coupled to a ram 810 of the press assembly 800 to uniformly transfer pressure to the lamination stack (i.e., assembly 850 where either the preform 400, or the preform 450, or both have been replaced by a conventional gel-pack or silicone mold tool).

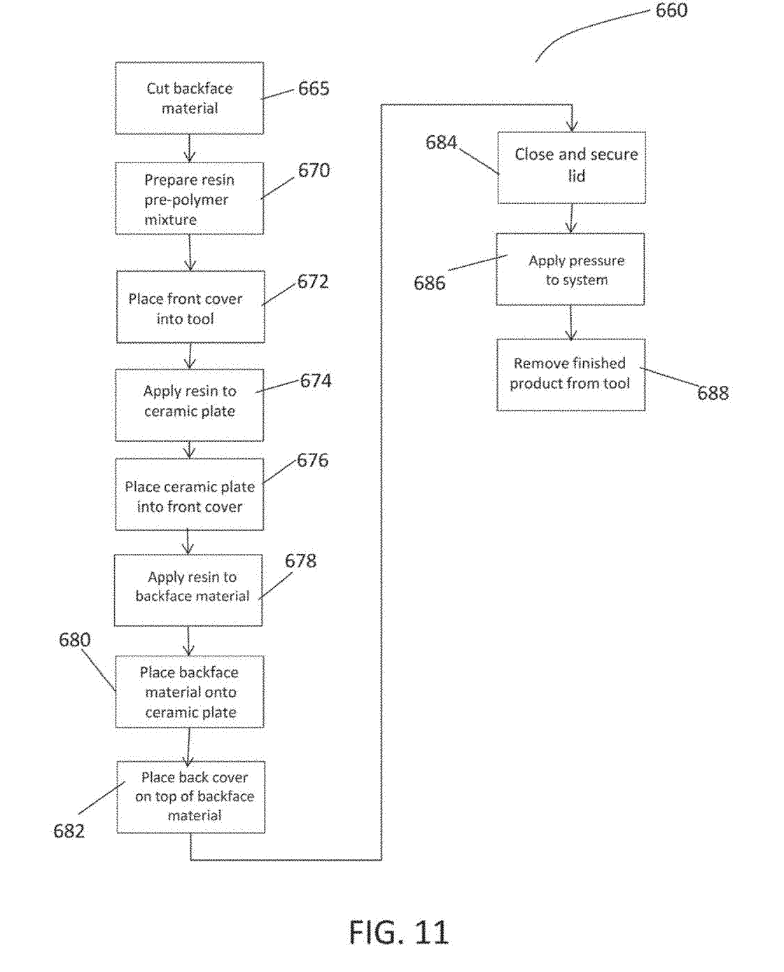

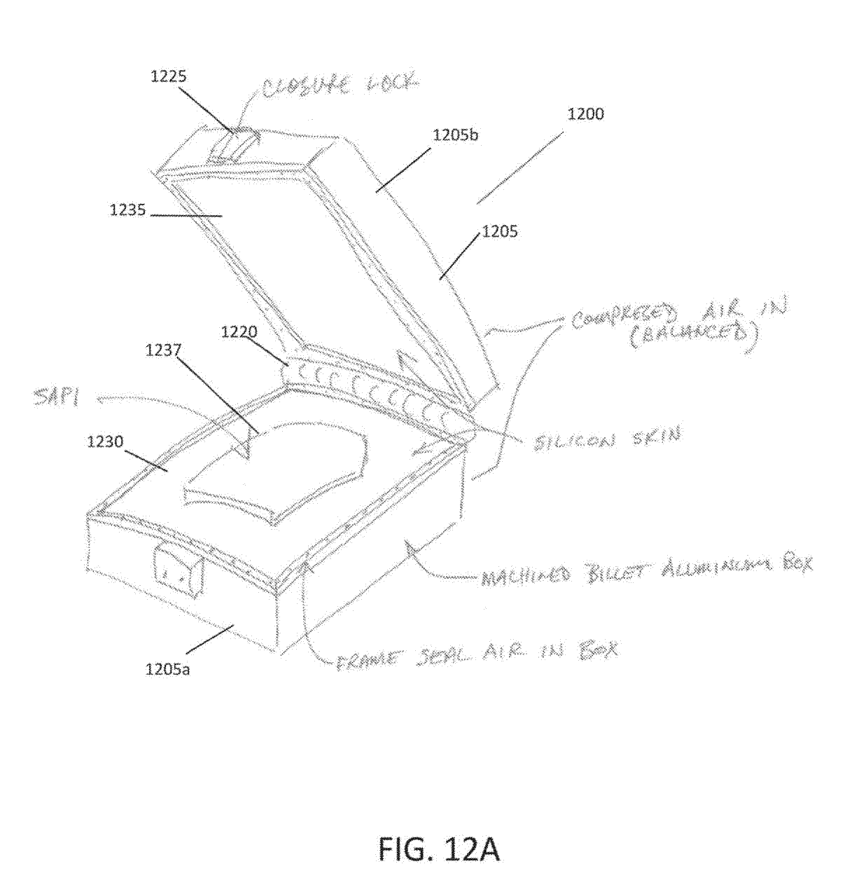

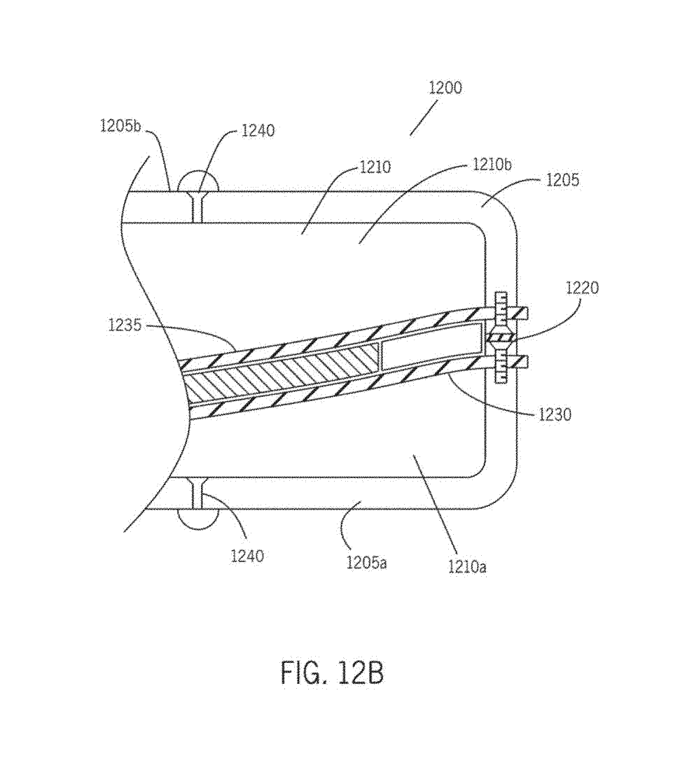

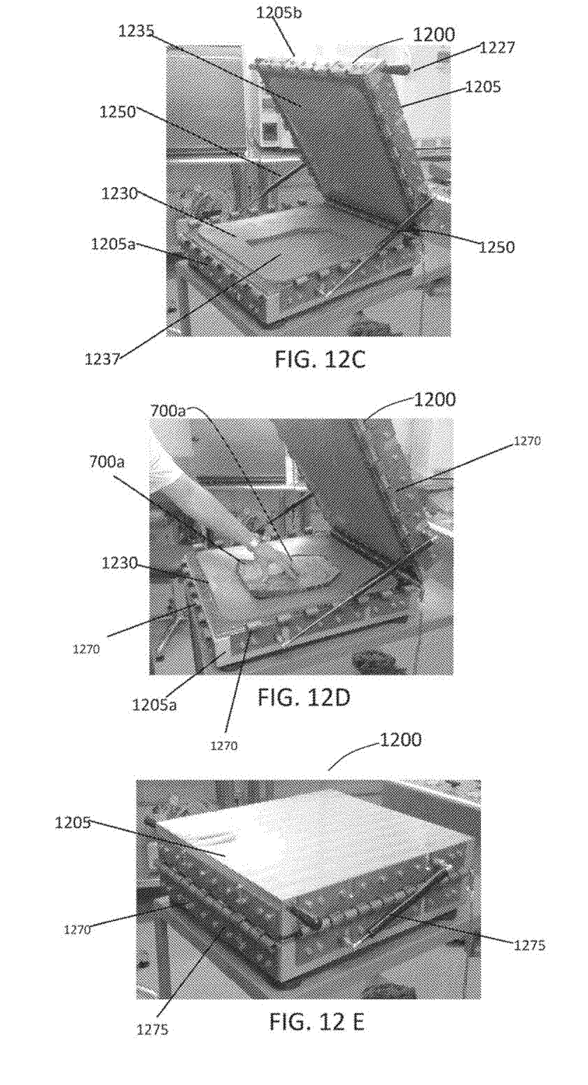

Some embodiments of the invention include processes for forming body armor composite 15 or other products using flexible mold technologies. For example, FIG. 11 illustrates a process to form a body armor composite 15 according to another embodiment of the invention that can utilize the flexible mold tool 1200. In some embodiments, the process 660 as described can use a flexible mold tool 1200 that does not require the use of a press such as press assembly 800 shown in FIG. 8. Instead, the flexible mold tool 1200 can comprise a portable and substantially sealable box including a pressure chamber (shown in FIGS. 12A-12E and described below).

Some embodiments of the invention include preparing an assembly of a plurality of layers 700a within the mold tool 1200, and using the mold tool 1200 to laminate the layers 700a to form a monolithic structure comprising the body armor composite 15. For example, some embodiments of the invention include preparing one or more backing layers 115 in step 665. In some embodiments, one or more layers of the body armor composite 15 can be cut, shaped and/or trimmed to a shape that is substantially the same as a strike-face layer 120. In some embodiments, the strike-face layer 120 can comprise a ceramic material. A resin pre-polymer mixture can be prepared in step 670, and a front cover can be placed in the flexible mold tool 1200 (step 672). In some embodiments, the front cover can comprise a plate cover layer 160. In some embodiments, the plate cover layer 160 can comprise a bump guard 100. In some embodiments, resin can be applied to the strike-face layer 120 in step 674, and the strike-face layer 120 can be placed into the plate cover layer 160 in the mold tool 1200. In some further embodiments, resin can be applied to the one or more backing layers 115 in step 678, and the one or more backing layers 115 can be placed onto the strike-face layer 120 in the mold tool 1200 in step 680. In some embodiments, step 682 can include positioning a back cover layer 165 onto the one or more backing layers 115, and step 684 can include closing the mold tool 1200. In step 686, pressure and/or heat can be applied to the mold tool 1200 for a specific time period, after which the body armor composite 15 can be removed from the mold tool 1200 in step 688.

In some embodiments, the one or more backing layers 115 can comprise a strike-face layer 120, a strike-face reinforcement layer 130, a catchment layer 140, and/or a back-face reduction layer 150. Further, in some embodiments, a bump guard 100 can be placed between the plate cover layer 160 and the strike-face layer 120. In some other embodiments, an optional fabric layer 170 can be placed over either the plate cover layer 160 and/or the back cover layer 165 to form an outer fabric layer. In some embodiments, the composite can be formed by thermally bonding some layers of various materials to themselves under pressure. In some embodiments, various electro-mechancial components can be integrated into the composite structure to form a multi-functional ballistically resistant composite. In some embodiments, a plurality of layers, materials and resins may be vacuum bagged within the mold or tool to evacuate gases and assure no gaseous inclusions compromise the composite.

FIG. 12A illustrates a perspective view of a flexible mold tool 1200 that can be used in place of a press assembly 800, and FIG. 12B illustrates a cross-sectional view of the flexible mold tool 1200 depicted in FIG. 12A in accordance with one embodiment of the invention. As shown, the flexible mold tool 1200 can comprise a clam-shell type hinged box housing 1205. For example, the flexible mold tool 1200 can comprise a clam-shell type hinged box housing 1205 forming an inner chamber 1210 including two hinged halves comprising a bottom portion 1205a and a top portion 1205b that are pivotably coupled using at least one hinge 1220. In one embodiment, one of the top portion 1205b or the bottom portion 1205a can be lifted in a direction away from the other member, wherein in one embodiment, the top portion 1205b is lifted substantially straight away from the bottom portion 1205a. In some embodiments, the flexible mold tool 1200 includes at least one flexible silicone membrane (a lower membrane 1230) positioned in a portion of the bottom portion 1205a of the mold tool 1200. “Membrane” is used herein to describe a broad range of flexible materials and structures useful in a molding process, some of which are substantially impermeable to air. When positioned in the bottom portion 1205a, a pressurizable lower chamber 1210a portion of the inner chamber 1210 of the mold tool 1200 can be formed. Further, the mold tool 1200 can also include at least one flexible silicone membrane (an upper membrane 1235) positioned in a portion of the top portion 1205b of the mold tool 1200. When positioned in the top portion 1205b, a pressurizable upper chamber 1210b portion of the inner chamber 1210 of the mold tool 1200 can be formed. In some embodiments, the mold tool 1200 can include at least one strut 1250 to support the portions 1205a, 1205b when the mold tool is pivoted to an open position (shown in FIGS. 12C and 12D), and to assist in the closure of the mold tool 1200 (shown in FIG. 12E). Further, in one embodiment, at least one handle 1227 can be included in the upper portion 1205 to assist a user with pivoting the upper portion 1205 (i.e. to open and close the mold tool 1200). Further, as depicted in FIG. 12A, some embodiments include at least one lock assembly 1225 to enable a user to secure and/or lock the portions 1205a, 1205b together. Moreover, as shown in FIGS. 12D and 12E, in some embodiments, the mold tool 1200 can include a plurality of outer lock rings 1270. In some embodiments, the outer lock rings 1270 can be used to lock and to assist in maintaining closure of the mold tool 1200 during pressurization of the tool and preparation of body armor 10, 15. For example, in some embodiments, outer lock rings 1270 can extend from and can be distributed along one or more edges of the bottom portion 1205a. Further, outer lock rings 1270 can extend from and can be distributed along one or more edges of the top portion 1205b. The outer lock rings 1270 distributed on opposing edges of the top portion 1205b and bottom portion 1205a can be alternately (i.e., complementarily) positioned to allow the top portion 1205b to close (i.e., to be positioned substantially parallel with the bottom portion 1205a) so that the outer lock rings 1270 on opposing edges become adjacently positioned. Further, in the closed position (as shown in FIG. 12E) the adjacently positioned outer lock rings 1270 can form at least one locking aperture 1275 at least partially extending along at least one side of the mold tool 1200 (see FIG. 12E). In some embodiments, a conventional locking rod can be passed through at least a partial length of the at least one locking aperture 1275 to enable the at least one locking aperture 1275 to substantially prevent separation of the portions 1205a, 1205b. Other mechanical locking methods to fix the position of portions 1205a and 1205b in the closed position during pressurization are within the scope of the present invention.

In some embodiments, either the lower membrane 1230 and/or the upper membrane 1235 can comprise a preform cavity 1237. In some embodiments, the height of the preform cavity 1237 is substantially equal to the thickness of the laminated body armor composite 15. A plurality of layers 700a can then be formed and laminated using the process 660. In the case of the use of the mold tool 1200 in place of the press assembly 800 in the process 500, the height of the preform cavity 1237 can include the thickness of the laminated body armor composite 10, 15 including the preforms 400, 450.

When using either of the processes 500, 660, layers 700a can be laminated by pressurizing the mold tool 1200. In some embodiments, each of the portions 1205a, 1205b can include at least one pressure port 1240. In some embodiments, the pressurizable lower chamber 1210a and upper chamber 1210b can be pressurized using a compressed gas (e.g., air). In some embodiments, the pressurizable lower chamber 1210a and upper chamber 1210b can be at least partially simultaneously pressurized. In some embodiments, after a specific period of time, the pressurizable lower chamber 1210a and upper chamber 1210b of the mold tool 1200 can be substantially depressurized, and opened to enable access to a lamination structure (e.g., such as a body armor composite 15). In some embodiments, a pressure between 100 psi and 150 psi is desirable.

In some embodiments, the housing 1205 can be formed from machined billet aluminum. In some further embodiments, the housing 1205 can comprise other metals such as steel or iron, or other suitable materials including fiber-reinforced plastics, polymers or other composite materials. Some embodiments further include a high durometer silicone frame formed around the perimeter of the interface between the portions 1205a, 1205b.

In some embodiments, one or more layers of body armor composite 10, 15 can be bonded at ambient room temperature. For example, in some embodiments, one or more layers of body armor composite 10, 15 can be bonded at a temperature between about 65° F. and about 80° F. In other embodiments, one or more layers of body armor composite 10, 15 can be bonded at a temperature that is higher than ambient room temperature (i.e., greater than about 80° F.). In some embodiments, the layers and/or the resin can be preheated to 90° F. or other desired temperatures to reduce cycle time.

The bonding temperature can vary depending on at least the composition of one or more layers included in the body armor composite 10, 15. The one or more layers and/or layers of additive bonding material can comprise a polymer and/or a pre-polymer or resin (or a combination thereof) that can be processed at a specified temperature and/or within a specified temperature range. As used herein, the term “pre-polymer” or “resin” can include any material composition that comprises either monomer or a mixture of monomers, and/or a partially reacted polymer or polymers that includes at least some unreacted monomer, and/or a polymer or mixture of polymers, and/or a combination thereof. Further, as used herein, the term “polymer” can included can include a material that comprises a polymer, a copolymer, a homopolymer, a blend of polymers, a blend of copolymers, a blend of homopolymers, or a combination thereof.

In some embodiments, one or more layers of the body armor composite 10, 15 can comprise at least one polymer. For example, in some embodiments, the body armor composite 10, 15 can include at least one strike-face reinforcement layer 130 that comprises at least one polymer. In some embodiments, the reinforcement layer 130 can include polymers that are composed of aramids (aromatic polyamides), poly(m-xylylene adipamide), poly(p-xylylene sebacamide), poly (2,2,2-trimethyl-hexamethylene terephthalamide), poly(piperazine sebacamide), poly(metaphenylene isophthalamide) (Nomex) and poly(p-phenylene terephthalamide) (Kevlar) and aliphatic and cycloaliphatic polyamides, such as the copolyamide of 30% hexamethylene diammonium isophthalate and 70% hexamethylene diammonium adipate, the copolyamide of up to 30% bis-(-amidocyclohexyl) methylene, terephthalic acid and caprolactam, polyhexamethylene adipamide (nylon 66), poly(butyrolactam) (nylon 4), poly(9-aminonanoic acid)nylon 9), poly(enantholactam) (nylon 7), poly(caprillactam) (nylon 8), polycaprolactam (nylon 6), poly(p-phenylene terephthalamide), polyhexamethylene sebacamide (nylon 6,10), polyaminoundecanamide (nylon 11), polydodecanolacatam (nylon 12), polyhexamethylene isophthalamide, polyhexamethylene terephthal amide, polycaproamide, poly(nonamethylene azelamide) (Nylon 9,9), poly(decamethylene azelamide) (nylon 10,9), poly(decamethylenesebacamide) (nylon 10,10), poly[bis-4-aminocyclohexyl)methanel, 10-decanedi-carboxamide](Qiana)(trans), or combination thereof; and aliphatic, cycloaliphatic and aromatic polyesters such as poly(1,4-cyclohexylidene dimethyl eneterephthalate) cis and trans, poly(ethylene-2,6-naphthalate), poly(1,4-cyclohexane dimethylene terephthalate) (trans), poly(decamethylene terephthalate, poly(ethylene terephthalate), poly(ethylene isophthalate), poly(ethylene oxybenzoate), poly(para-hydroxy benzoate), poly(beta,beta dimethylpropiolactone), poly(decamethylene adipate), poly(ethylene succinate) and the like.

In some other embodiments, reinforcement layer 130 can comprise at least one polymer formed of extended chain polymers by the reaction of beta-unsaturated monomers of the formula:

R₁R₂—C═CH₂

where R₁ and R₂ are either identical or different, and are hydrogen, hydroxyl, halogen, alkylcarbonyl, carboxy, alkoyxycarbonyl, heterocycle or alkyl or aryl, where the alkyl or aryl can be substituted with one or more substituents including alkoxy, cyano, hydroxyl, akyl or aryl. In some embodiments, extended chain polymers can be composed of polystyrene, polyethylene, polypropylene, poly(1-octadecene), polyisobutylene, poly(1-pentene), poly(2-methylstyrene), poly(4-methyl styrene), poly(1-hexene), poly(1-pentene), poly(4-methoxystyrene), poly(5-methyl-1-hexene), poly(4-methylpentene), poly(1-butene), poly(3-methyl-1-butene), poly(3-phenyl-1-propene), polyvinyl chloride, polybutylene, polyacrylonitrile, poly(methyl pentene-1), poly(vinyl alcohol), poly(vinyl-acetate), poly(vinyl butyral), poly(vinyl chloride), poly(vinylidene chloride), vinyl chloride-vinyl acetate chloride copolymer, poly(vinylidene fluoride), poly(methyl acrylate, poly(methylmethacrylate), poly(methacrylonitrile), poly(acrylamide), poly(vinyl fluoride), poly(vinyl formal), poly(3-methyl-1-butene), poly(1-pentene), poly(4-methyl-1-butene), poly(1-pentene), poly(4-methyl-1-pentene), poly(1-hexane), poly(5-methyl-1-hexene), poly(1-octadecene), poly(vinyl cyclopentane), poly(vinylcyclohexane), poly(a-vinylnaphthalene), poly(vinyl methyl ether), poly(vinylethylether), poly(vinyl propylether), poly(vinyl carbazole), poly(vinyl pyrrolidone), poly(2-chlorostyrene), poly(4-chlorostyrene), poly(vinyl formate), poly(vinyl butyl ether), poly(vinyl octyl ether), poly(vinyl methyl ketone), poly(methylisopropenyl ketone), poly(4-phenylstyrene) and the like.

In some embodiments, one or more layers of body armor composite 10, 15 can be bonded to one or more layers of body armor composite 10, 15 using a thermosetting polymer. In some embodiments, thermosetting resin pre-polymer can be applied to at least one side of the at least one of the layers. In some embodiments, a thermosetting resin pre-polymer can be applied to both sides of at least one of the layers. In some embodiments, one or more layers of the body armor composite 10, 15 can be bonded to one or more other layers of body armor composite 10, 15 using an epoxy resin based polymer or pre-polymer. In some other embodiments, one or more layers of body armor composite 10, 15 can be bonded to one or more other layers of body armor composite 10, 15 using a vinyl ester based polymer. In some further embodiments, both an epoxy resin based polymer and a vinyl ester based polymer can be used.

In some embodiments of the invention, the thermosetting resin can comprise an epoxide technology. For example, in some embodiments, epoxies based on saturated or unsaturated aliphatic, cycloaliphatic, aromatic and heterocyclic epoxides can be used. For example, useful epoxides include glycidyl ethers derived from epichlorohydrin adducts and polyols, particularly polyhydric phenols. Another useful epoxide is the dlglycidyl ether of hisphenol A. Additional examples of useful polyepoxides are resorcinol diglycidyl ether, 3,4-epoxy-6-methylcyclohexylmethyl-9,10-epoxystearate, 1,2,-bis(2,3-epoxy-2-methylpropoxy)ethane, diglycidyl ether of 2,2-(p-hydroxyphenyl) propane, butadiene dioxide, dicyclopentadiene dioxide, pentaerythritol tetrakis(3,4 epoxycyclohexanecarboxylate), vinylcyclohexene dioxide, divinylbenzene dioxide, 1,5-pentadiol bis(3,4-epoxycyclohexane carboxylate), ethylene glycol bis(3,4-epoxycyclohexane carboxylate), 2,2-diethyl-1,3-propanediol bis(3,4 epoxycyclohexanecarboxylate), 1,6-hexanediol bis(3,4-epoxycyclohexanecarboxylate),2-butene-1,4-diol-bis(3,4-epoxy-6-methylcyclohexane carboxylate), 1,1,1-trimethylolpropane-tris-(3,4-epoxycyclohexane carboxylate), 1,2,3-propanetriol tris(3,4-epoxycyclohexanecarboxylate), dipropylene glycol bis(2-ethylexyl-4,5-epoxycyclohexane-1,2-dicarboxylate), diethyleneglycol-bis(3,4-epoxy-6-methylcyclohexane carboxylate), triethylene glycol bis(3,4-epoxycyclohexanecarboxylate),3,4-epoxycyclohexyl-methyl-3,4-epoxycyclohexanecarboxylate,3,4-epoxy-1-methylcyclohexyl methyl-3,4-epoxy-1-methylcyclohexane-carboxylate, bis(3,4-epoxycyclohexylmethyl) pimelate, bis(3,4-epoxy-6-methylenecyclohexylmethyl)maleate, bis(3,4-epoxy-6-methylcyclohexylmethyl) succinate, bis(3,4-epoxycyclohexylmethyl) oxalate, bis(3,4-epoxy-6-methylcyclohexylmethyl) sebacate, bis(3,4-epoxy-6-methylcyclohexylmethyl)adipate, bis(3,4-epoxycyclo-hexylmethyl) terephtalate, 2,2′-sulfonyldiethanol bis(3,4-epoxycyclohexanecarboxylate), N,N′-ethylene bis(4,5-epoxycyclohexane-1,2-dicarboximide), di(3,4-epoxycyclohexylmethyl)-1,3-tolylenedicarbamate,-3,4-epoxy-6-methylcyclohexane carboxaldehyde acetal, 3,9-bis(3,4-epoxycyclohexyl) spirobi-(methadioxane), and the like.

As noted above, in some further embodiments, thermosetting resins based on vinyl ester technology can be used. For example, in some embodiments, thermosetting resins based on aromatic vinyl esters can be used. These can include a condensation product of epoxide resins and unsaturated acids usually diluted in a compound having double bond unsaturation such as vinyl aromatic monomer (e.g., styrene and vinyl toluene, and diallyl phthalate). Illustrative of useful vinyl esters are diglycidyl adipate, diglycidyl isophthalate, di(2,3-epoxybutyl) adipate, di(2,3-epoxybutyl) oxalate, di(2,3-epoxyhexyl) succinate, d(3,4-epoxybutyl) maleate, d(2,3-epoxyoctyl) pimelate, di(2,3-epoxybutyl) phthalate, di(2,3-epoxyoctyl) tetrahydrophthalate, di(4,5-epoxy-dodecyl) maleate, di(2,3-epoxybutyl) terephthalate, di(2,3-epoxypentyl) thiodipropionate, di(5,6-epoxy-tetradecyl) diphenyldicarboxylate, di(3,4-epoxyheptyl) sulphonyldibutyrate, tri(2,3-epoxybutyl) 1,2,4 butanetricarboxylate, di(5,6-epoxypentadecyl) maleate, di(2,3-epoxybutyl) azelate, di(3,4-epoxybutyl) citrate, di(5,6-epoxyoctyl) cyclohexane-1,3-dicarboxylate, di(4,5-epoxyoctadecyl) malonate, bisphenol-A-fumaric acid polyester and the like.

In some embodiments, at least a portion of the body armor composite 10, 15 can include a filler material. For example, some embodiments can include a thermoplastic or thermosetting resin that includes at least some filler material dispersed through at least a portion of the body armor composite 10, 15. In some embodiments, the filler material can be dispersed substantially homogenously through at least a portion of at least one layer of the body armor composite 10. In some other embodiments, the filler material can be substantially unevenly distributed through at least a portion of the body armor composite 10, 15. For example, in some embodiments, the filler material can be dispersed substantially unevenly through at least a portion of at least one layer of the body armor composite 10, 15. In some embodiments, the filler material can be amorphous or crystalline, organic or inorganic material. In some other embodiments, the particle size of the filler material can be between 1-10 microns. In some other embodiments, at least some portion of the filler material can be sub-micron. In some in some other embodiments, the thermosetting resin can contain nano-sized particle filler material.

In some embodiments, one or more layers of the body armor composite 10, 15 can comprise an inorganic material. In some embodiments, at least a portion of the aforementioned filler material can comprise an inorganic material. For example, in some embodiments, the body armor composite 10, 15 can include at least one strike-face reinforcement layer 130 that comprises at least one inorganic material. The body armor composite 10, 15 can include at least one strike-face 120, and in some embodiments, the strike-face 120 can comprise at least one inorganic material. The inorganic material can include a ceramic material, a glass material, a metal material, or a combination thereof. In some embodiments, the inorganic material can include materials comprising S-glass, E-glass, silicon carbide, asbestos, basalt, alumina, aluminum oxynitride, spinel (such as MgAb0₄), alumina-silicate, quartz, zirconia-silica, and/or sapphire. In some embodiments, the inorganic material can comprise a fibrous, whisker, and/or filament type material. For example, in some embodiments, the inorganic material can comprise a ceramic filament, boron filament, and/or carbon filaments. In some other embodiments, metallic or semi-metallic filaments composed of boron, aluminum, steel and titanium can be used.

In some embodiments, one or more layers of the body armor composite 10, 15 can comprise a polymer with an ultra-high molecular weight. For example, in some embodiments, the body armor composite 10, 15 can include at least one catchment layer 140, and in some embodiments, the catchment layer 140 can comprise ultra-high-molecular-weight polyethylene (“UHMWPE”), also known as high-modulus polyethylene (“HMPE”). In some embodiments, the molecular weight of the UHMWPE can approach 1 million. In some further embodiments, the molecular weight of the UHMWPE can be in the range 1-3 million. In some other embodiments, the molecular weight of the UHMWPE can be in the range 3-6 million. In some other embodiments, the molecular weight of the UHMWPE can exceed 6 million. In some further embodiments, one or more layers of the body armor composite 10, 15 can comprise a highly crystalline or high oriented polymer or copolymer of polypropylene.

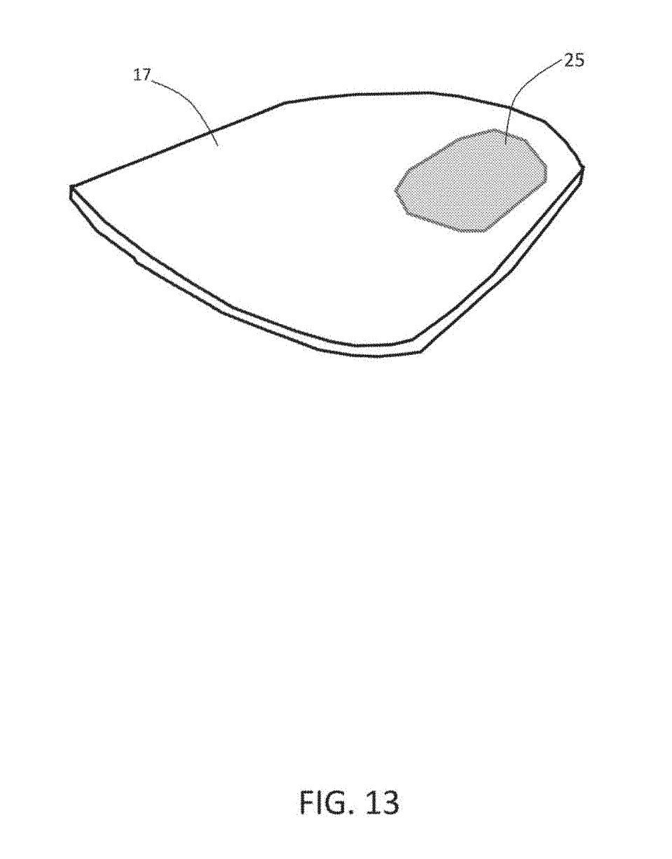

In some further embodiments, the body armor composite 10, 15 can include at least one enhanced protection region 25. For example, as shown in FIG. 13, a body armor composite 10, 15 can comprise at least one layer 17 including an enhanced protection region 25. In some embodiments, enhanced protection region 25 can include an additional layer or thickness or density. In some embodiments, enhanced protection region 25 can include an energy absorbing layer, a penetration resistant layer, a reinforcing layer, an impact absorbing layer, a fragmentation minimizing layer or a combination of these layers. In other embodiments, enhanced region 25 can include a material that is different from the surrounding layer to which it is attached. In some embodiments, one or more layers 700a can include at least one enhanced region 25 integrated, embedded, or coupled to one or more layers 700a (e.g., any one of the layers 700a can include a layer 17). In some embodiments, layers 700b can include an enhanced protection region 25.

Some embodiments can include a plate cover layer 160. For example, in some embodiments, the body armor composite 10, 15 can be fabricated with a plate cover layer 160 and/or a back cover layer 165. The use of at least one cover layer including a plate cover layer 160 and/or a back cover layer 165 can control delamination, reduce spall and provide an encapsulation of the ballistic plate, and can provide environmental protection, and reduce back-face deformation. The cover layers 160, 165 can also provide waterproofness, provide a cosmetic appearance, and provide surface for attaching labeling. In some further embodiments, functional devices can be included (e.g., embedded) in the layers 160, 165 such as for example RFID chips, and one or more sensors (e.g., impact sensors, and heath monitoring sensors). Combining the molding pressure and heat can reduce the temperature required for curing and, therefore, allows more sensitive electronics to be incorporated into the the molded part 10 and 15

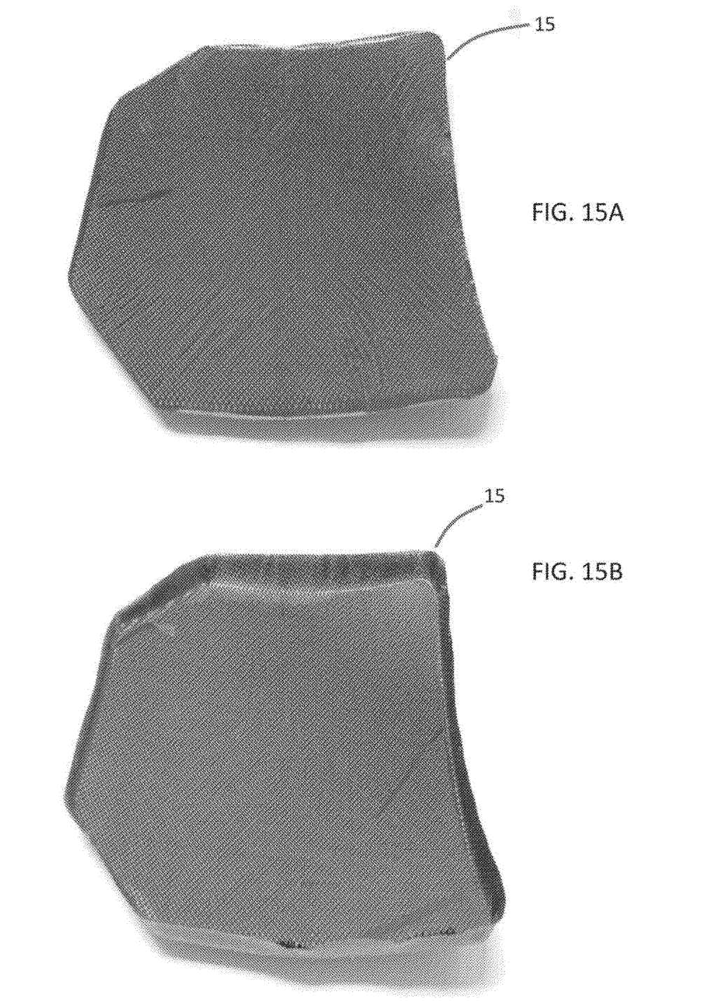

FIG. 14 illustrates an expanded layer view of a plurality of layers of body armor composite 15 in accordance with one embodiment of the invention, and FIG. 15A-15B illustrates views of body armor composite 15 including covers 160, 165 in accordance with one embodiment of the invention. In some embodiments, the plate cover layer 160 and/or the back cover layer 165 can be pre-fabricated and the body armor composite 15 and one or more layers 700a can be prefabricated, joined and formed as a single monolithic composite using the methods as described herein. In some further embodiments, the plurality of layers 700a forming the body armor composite 15 can be pre-fabricated (without the plate cover layer 165 and/or the plate cover layer 160), and the plate cover layer 169 and/or the back cover layer 165 can be fabricated onto the previously formed body armor composite 15 using the methods as described earlier using processes 500, 660. As shown in FIG. 14, in some embodiments, the body armor composite can comprise a plurality of layers including a plate cover layer 160, a back cover layer 165, at least one backing layer 115, and at least one strike-face layer 120. Moreover, the backing layers 115 can include a plurality of layers and can comprise a strike-face layer 120, a strike-face reinforcement layer 130, a catchment layer 140, and/or a back-face reduction layer 150. Further, in some embodiments, a bump guard 100 can be placed between the plate cover layer 160 and the strike-face layer 120, and an optional fabric layer 170 can be placed over either the plate cover layer 160 and/or the back cover layer 165 to form an outer fabric layer as described in detail previously.

In some embodiments, the plate cover layer 160 and/or the back cover layer 165 can comprise a ballistic layer or a ballistic reinforcement layer. The plate cover layer 160 and/or the back cover layer 165 can include or comprise a monocoque structure (e.g., a monocoque truss structure). In some embodiments, the layers 160, 165 can be fabricated onto the previously formed body armor composite 10, 15 using the methods as described herein, and can include hot pressure molding, and pre-heated materials and cold pressure forming. In some embodiments, the layers 160, 165 can be fabricated and formed on a tool at a temperature between about 65° F. and about 80° F. In some embodiments, the layers 160, 165 can be formed using a resin based on an epoxide based polymer or a vinyl ester based resin. In some other embodiments, the layers 160, 165 can be formed using a resin based on any one of the epoxide based polymer or vinyl ester based resin polymers. In some embodiments, the layers 160, 165 can incorporate a bump guard 100. In some embodiments, the layers 160, 165 can be any shape, and cover any type or shape from flat to multi-curve armor. In some embodiments, the layers 160, 165 can be any combination of a top and bottom, front and back, front all sides and a two dimensional back piece for closure. Moreover, in some embodiments, the layers 160, 165 can be one piece, two pieces or any number of parts.

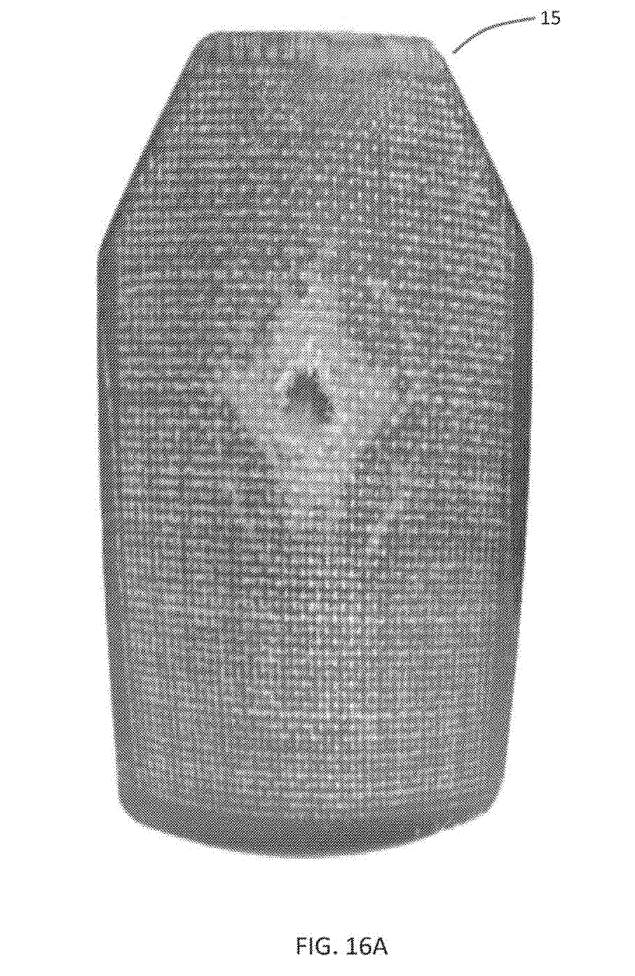

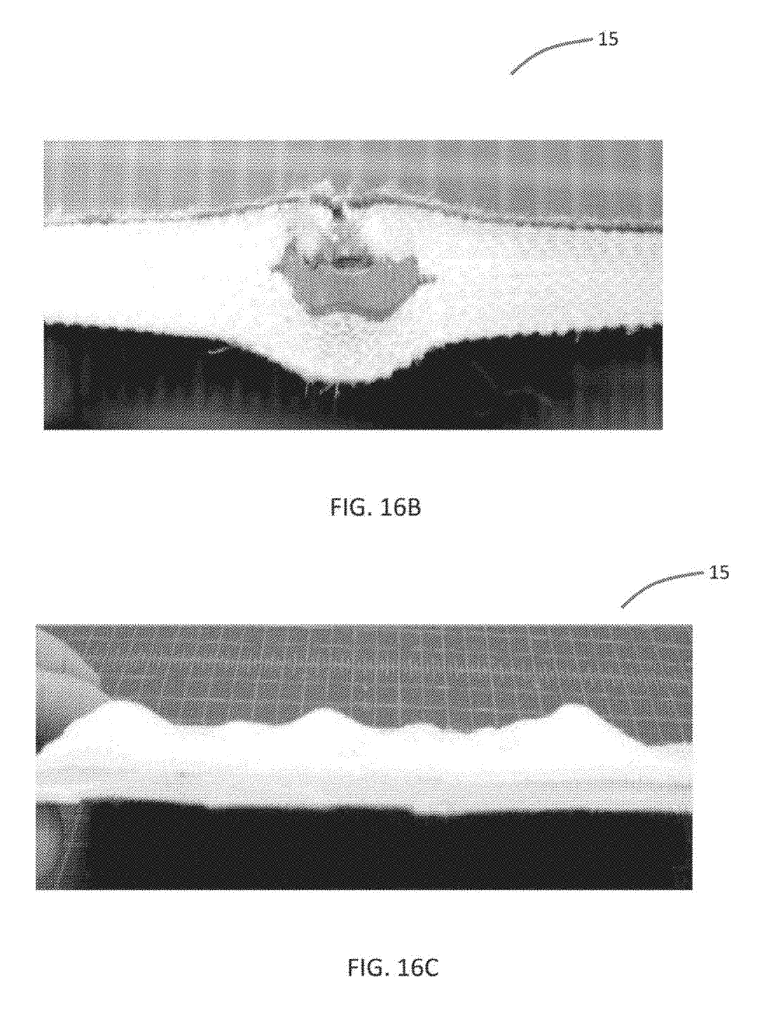

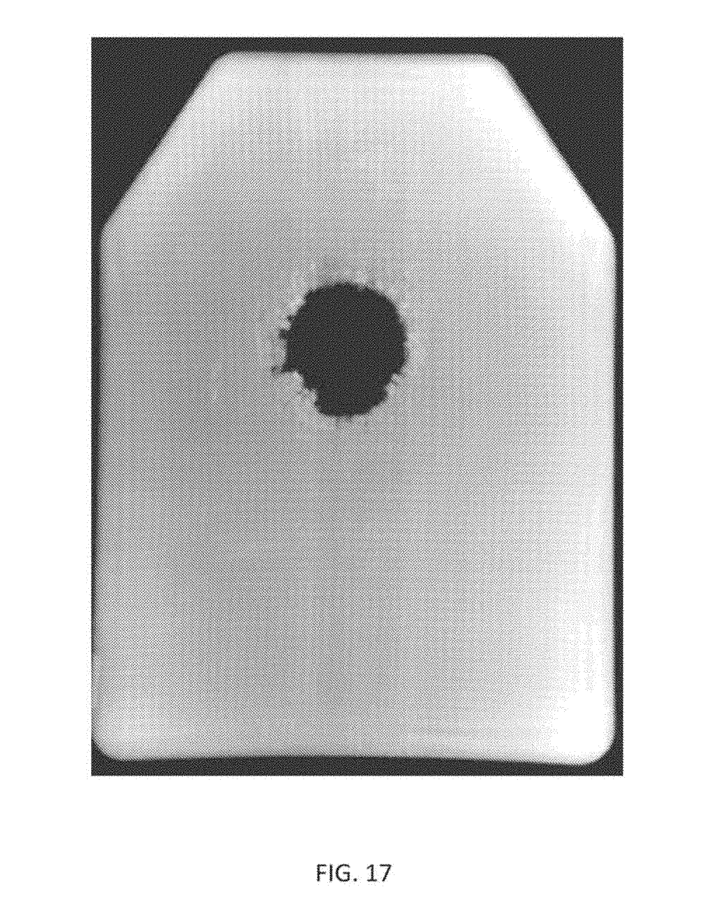

Ballistic plates produced by the materials and methods described herein have been tested under the 16.0 mm BFD, 124 grain 9×19 mm FMJ RN projectile requirement. FIG. 16A illustrates a front view of body armor composite 15 after ballistic round penetration in accordance with one embodiment of the invention, and FIG. 16B illustrates a cross-sectional view of body armor composite 15 after ballistic round penetration in accordance with one embodiment of the invention. As shown, the body armor composite 15 can prevent complete penetration of the 9 mm round. Further, FIG. 16C illustrates a side view of body armor composite 15 after multiple ballistic round penetrations in accordance with one embodiment of the invention. As shown, the body armor composite 15 has contained seven 9 mm rounds. For comparison purposes, FIG. 17 illustrates views of a prior art body armor composite after ballistic round penetration using the same test conditions, and shows complete penetration of the round and damage to the top and bottom surfaces of the plate.

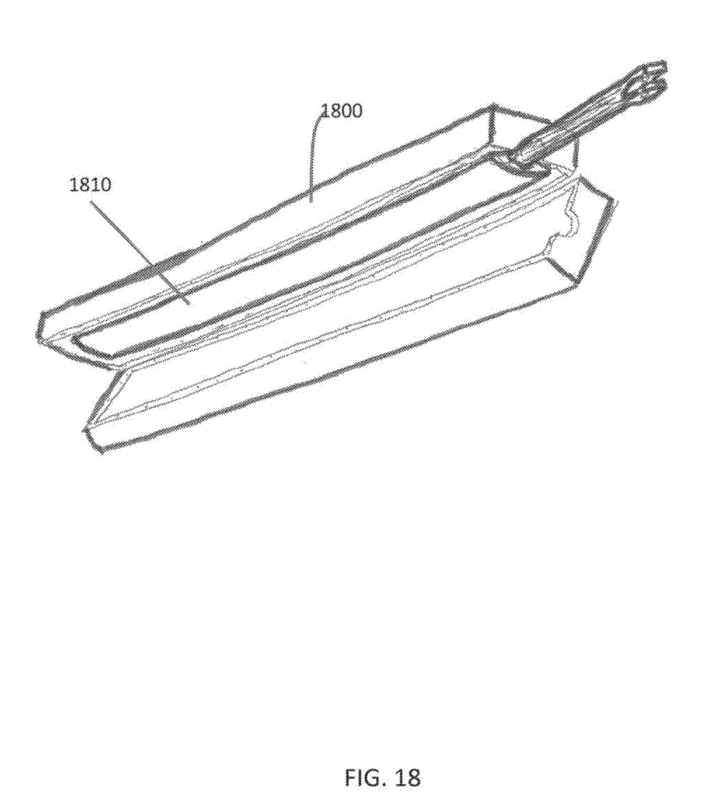

In some embodiments, the mold tool 1200 can be fabricated in various sizes and shapes to accommodate different armor structures. For example, FIG. 18 illustrates a perspective view of a helicopter blade 1810 fabricated using the process 660 of FIG. 11 in accordance with one embodiment of the invention.

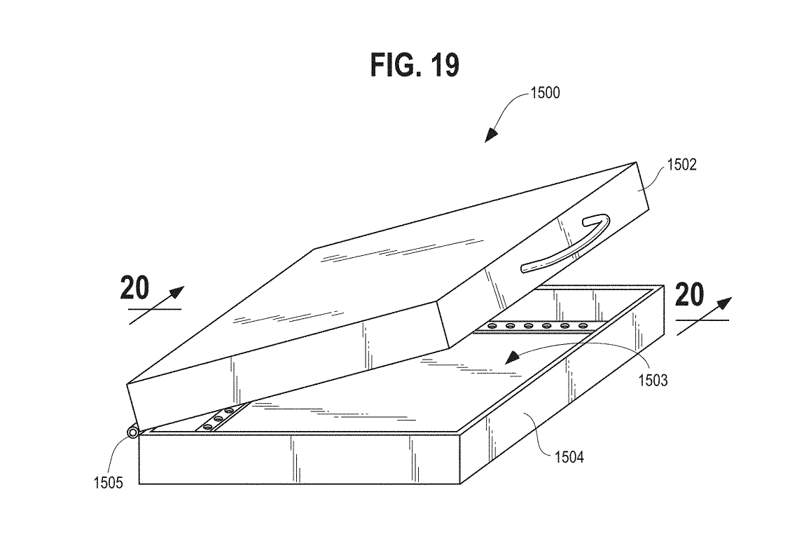

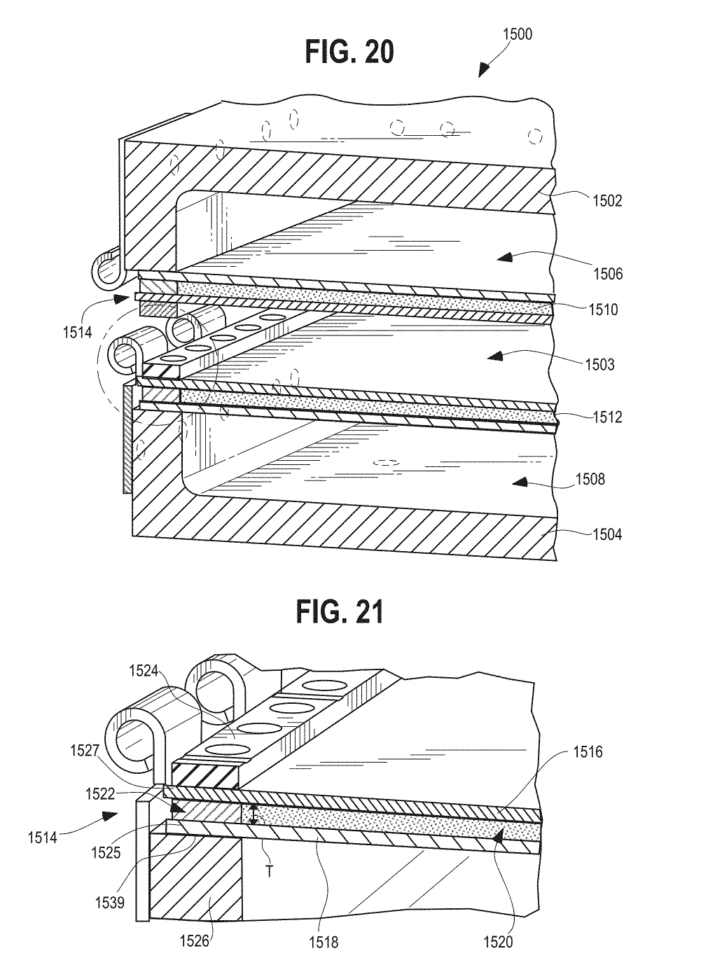

FIGS. 19-23 illustrate another embodiment of a molding tool assembly 1500 for molding body armor composite 15. Molding tool assembly 1500 comprises a tool upper 1502, and a tool lower 1504 that when closed define a molding chamber 1503. In one embodiment, tool upper 1502 and tool lower 1504 are pivotally connected by a hinge 1505. As shown in FIG. 20, tool upper 1502 includes an upper pressure chamber 1506 and an upper chamber thermal diaphragm 1510, wherein upper chamber thermal diaphragm 1510 separates upper pressure chamber 1506 from mold chamber 1503. Tool lower 1504 includes a lower pressure chamber 1508 and a lower chamber thermal diaphragm 1512, wherein lower chamber thermal diaphragm 1512 separates lower pressure chamber 1508 from mold chamber 1503. The upper chamber thermal diaphragm 1510 and the lower chamber thermal diaphragm 1512 each comprise a thermal diaphragm subassembly 1514.

FIG. 21 illustrates thermal diaphragm subassembly 1514 comprising a thermal transfer membrane 1516 and a pressure bearing membrane 1518 separated by a fluid dispersion layer 1520. Subassembly 1514 includes a fluid dispersion manifold 1522 is disposed above an outer edge 1525 of pressure bearing membrane 1518, wherein outer edge 1525 of pressure bearing membrane 1518 bears upon a surface 1529 of sidewall 1526 of the molding tool assembly and under an outer edge 1527 of thermal transfer membrane 1516. Fluid dispersion manifold 1522 may be attached to sidewall 1526 to apply a compression to said pressure bearing membrane 1518 to substantially or completely seal the pressure bearing membrane 1518 to the surface 1539 of sidewall 1526 such that pressure can be applied within the pressure chambers 1506 and 1508. The fluid dispersion manifold 1522 may extend around the perimeter of the pressure bearing membrane 1518 and/or the sidewall 1526 of the molding tool 1500. Subassembly 1514 also includes a compression/sealing ring 1524 bearing upon outer edge 1527 of thermal transfer membrane 1516 wherein the compression/sealing ring 1524 fastens to the fluid dispersion manifold 1522 and/or the sidewall 1526 to compress and substantially or completely seal the thermal transfer membrane 1516 against the fluid dispersion manifold 1522 so that fluid can be retained within fluid dispersion layer 1520 without leaking into molding chamber 1503 or pressure chamber 1506 or 1508. The compression/sealing ring 1524 may extend around the perimeter of the thermal transfer membrane 1516 and/or the sidewall 1526 of the molding tool 1500. A thickness T of the fluid dispersion manifold 1522 defines a distance between thermal transfer membrane 1516 and pressure bearing membrane 1518. Fluid dispersion layer 1520 may comprise a fluid dispersion media that is disposed within the distance between thermal transfer membrane 1516 and pressure bearing membrane 1518.

Fluid dispersion layer 1520 may comprise a fluid dispersion media of a material allowing fluid to flow through the media, but having a compressive strength greater than the pressure applied to body armor composite 10 formed therein. In one embodiment, fluid dispersion media is a mesh-like material or a porous material. Thermal transfer membrane 1516 and pressure bearing membrane 1518 are preferable a flexible membrane and, in one embodiment, may have elastic capabilities to stretch as necessary to conform with the shape of the molded body armor composite 10 when pressure is applied. In one embodiment, the membranes used may be made from one or more of high temperature silicone, food grade silicone, chemically resistant silicone, chemically resistant silicone, fabric reinforced silicone or any elastomer with the same properties.

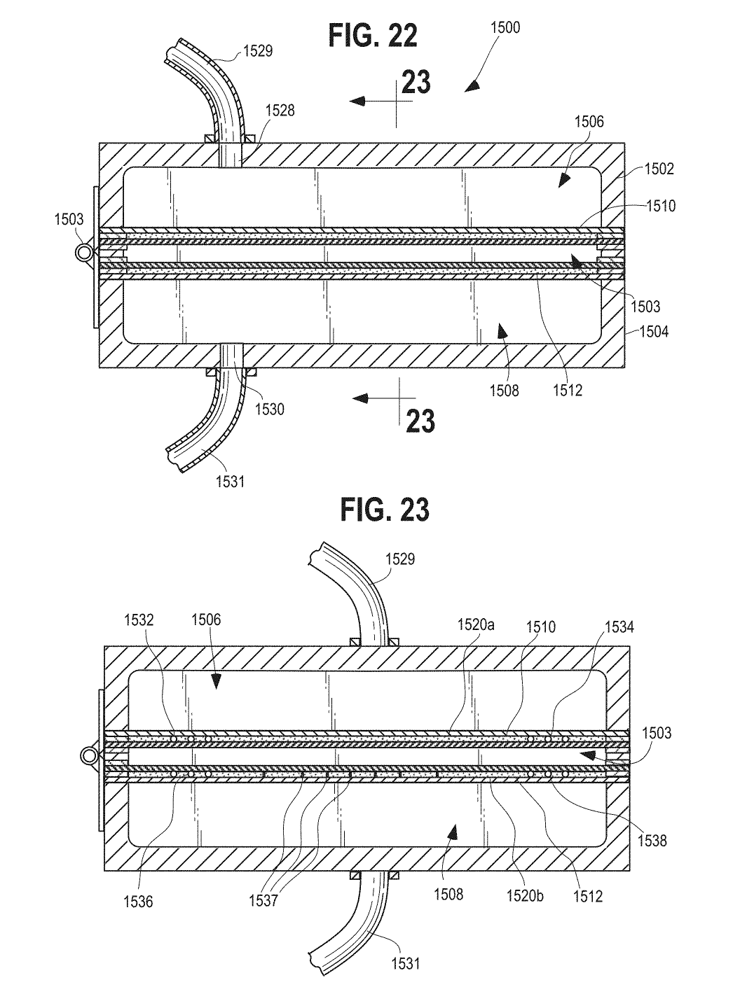

FIG. 22 illustrates a cross-section of the mold tool 1500 in a closed position showing a tool upper pressurized fluid inlet 1528 in fluid communication with an upper fluid supply 1529 to supply a pressurized fluid into upper chamber 1506, and a tool lower 1504 including a lower pressurized fluid inlet 1530 in fluid communication with an lower fluid supply 1531 to supply pressurized fluid into lower chamber 1508. Pressurized fluid may be air, a liquid such as water, or any other fluid known to be used to apply pressure in a molding process.

FIG. 23 shows one embodiment of tool 1500 that includes an upper temperature fluid inlet 1532 and an upper temperature fluid outlet 1534, each in fluid communication with fluid dispersion layer 1520a of upper chamber thermal diaphragm 1510. In addition, in one embodiment, tool 1500 may include a lower temperature fluid inlet 1536 and a lower temperature fluid outlet 1538, each in fluid communication with fluid dispersion layer 1520b of lower chamber thermal diaphragm 1512. Heated or cooled fluid can be introduced into fluid dispersion layers 1520a and 1520b through inlets 1532 and 1536 from a fluid supply (not shown), dispersed through the fluid dispersion media of fluid dispersion layers 1520a and 1520b, and the removed through outlets 1534 and 1538 respectively. In one embodiment, the inlets 1536 and 1538 may be included in fluid dispersion manifold 1522. In one embodiment, the heated fluid circulated through the thermal dispersion layers 1520a and 1520b can be set to a temperature to cause melting or curing of layers of body armor composite 10 formed therein.

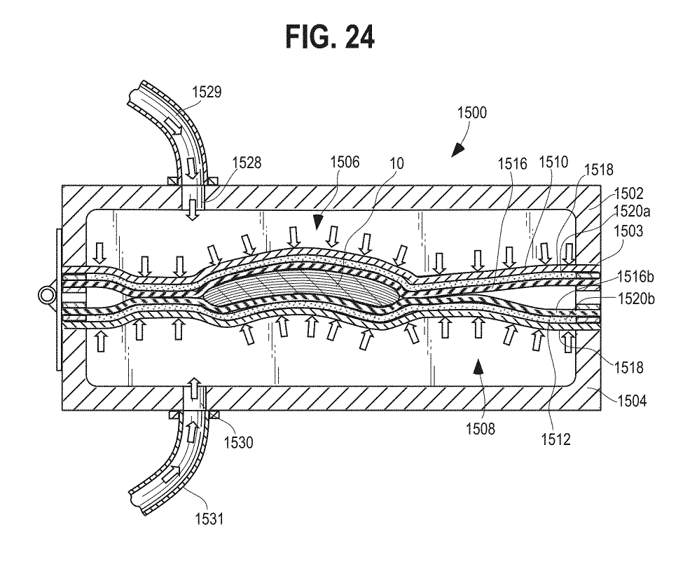

FIG. 24 illustrates mold tool 1500 during the molding process, wherein layers of body armor composite 10 are inserted into mold cavity 1503 with tool upper 1502 and tool lower 1504 disposed in an open position, and tool upper 1502 is closed so that body armor composite 10 is sandwiched between upper chamber thermal diaphragm 1510 and lower chamber thermal diaphragm 1512. A locking mechanism (not shown) may be implemented to secure the tool upper 1502 and the tool lower 1504 in a closed position. Pressurized fluid is introduced into upper pressure chamber 1506 and lower pressure chamber 1508 to apply a pressure to compress body armor composite 10 between upper chamber thermal diaphragm 1510 and lower chamber thermal diaphragm 1512. Thermal diaphragms 1510 and 1512 may be a flexible membrane and, in one embodiment, may have elastic capabilities to stretch as necessary to conform to the shape of the molded body armor composite 10 during the application of pressure. This embodiment allows the pressure to be applied evenly and substantially normal (90 degrees) to the various layers and surfaces of the composite molded armor part. This feature may eliminate bunching and stretching of the layers of the molded body armor composite 10 experienced with current processes. While pressure is applied to the body armor composite 10, heated fluid may be introduced through inlets 1532 and 1536 into fluid dispersion layers 1520a and 1520b to heat the body armor composite 10. The elevated temperature may provide curing of resin and/or decrease the time period for curing a resin layer. Moreover, the elevated temperature through introducing the heated fluid may be sufficient to melt one or more layers to create a composite material and/or providing a temperature sufficient to thermally bond a plurality of layers or material to form the body armor composite 10. The heated fluid circulates through the media (if any) of fluid dispersion layer 1520a and 1520b. In one embodiment, the media may be a flexible mesh-like material of a thickness that has a compressive strength significantly higher that the pressure which exists in the upper or lower pressure chambers and, as such, the heated fluid can flow through the media even while the upper and lower chambers 1506 and 1508 are pressurized and applying force to the body armor composite 10 being formed. Further, the fluid dispersion manifold 1522 can be modified to provide any number of inlets or outlets to ensure the necessary fluid throughput to provide the desired temperature.

The application of heat and pressure may be maintained in tool 1500 until the molding of body armor composite 10 is complete or otherwise as desired. At this time, the flow of heating fluid is stopped and a cooling fluid may be introduced into the fluid dispersion layers 1520a and 1520b to reduce the temperature of the part for handling, and the pressurized fluid may be removed through inlet 1528 or 1530, which operate as an outlet, or through another stand-alone fluid drain or outlet (not shown). The locking mechanism may be disengaged and the body armor composite tool 10 may be removed from molding chamber 1503 of the molding tool 1500.

Advantages of the construction of tool 1500 are that the heat transfer fluid does not need to be pressurized, which reduces the equipment needed and increases the overall safety of the tool 1500. Further, in one embodiment, the fluid dispersion media in fluid dispersion layers 1520a and 1520b may be include one or more baffles 1537 arranged to direct the flow of fluid to create thermal flow patterns based upon the needs of the body armor composite 10 being formed. The flow pattern in the media may be combined with the location of the inlets and outlets to provide distinct thermal zones that are created and controlled independently to optimize the molding process. Moreover, the upper and lower thermal diaphragm systems described herein may also be controlled in concert or independently.

The flexible molding processes described herein can also be used to form kayaks, wing spars, vehicle body panels and a wide range of other products. Some embodiments of the invention enable better control of resin content without inducing significant localized stresses in the resulting composites. Some embodiments also enable the replacement of pre-impregnated materials with unimpregnated materials which can offer excellent structural characteristics at lower cost.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

1. An armor production tool, comprising:
a tool upper part comprising an upper thermal diaphragm assembly that at least partially defines an upper pressure chamber and an upper molding chamber;
a tool lower part operably connected to the tool upper part, the tool lower part comprising a lower thermal diaphragm assembly that at least partially defines a lower pressure chamber and a lower molding chamber;
wherein one of the upper thermal diaphragm assembly or the lower thermal diaphragm assembly comprise a thermal transfer membrane proximate the respective upper or lower molding chamber, a pressure bearing membrane proximate the respective upper or pressure chamber and a fluid dispersion layer disposed between the thermal transfer membrane and the pressure bearing membrane; and
wherein the fluid dispersion layer is in fluid communication with a supply of fluid for introducing one of heated or cooled fluid into the fluid dispersion layer.

2. The armor production tool of claim 1, wherein at least one of said pressure chamber of said tool upper part and said pressure chamber of said lower upper part is in fluid communication with a first pressurized fluid supply.

3. The armor production tool of claim 1, wherein pressure chamber of said tool upper part is in fluid communication with said first pressurized fluid supply and said pressure chamber of said lower upper part is in fluid communication with a second pressurized fluid supply.

4. The armor production tool of claim 1, wherein the tool upper part and the tool lower part are moveable between an open position and a closed position.

5. The armor production tool of claim 1, wherein said thermal transfer membrane, said pressure bearing membrane, and said fluid dispersion layer are flexible.

6. The armor production tool of claim 1, wherein said thermal transfer membrane, said pressure bearing membrane, and said fluid dispersion layer are elastic.

7. The armor production tool of claim 1, wherein one of the upper thermal diaphragm assembly or the lower thermal diaphragm assembly further comprises a fluid dispersion manifold disposed to sandwich said pressure bearing membrane between said fluid dispersion manifold and a sidewall of said armor production tool.

8. The armor production tool of claim 6, wherein one of the upper thermal diaphragm assembly or the lower thermal diaphragm assembly further comprises a compression/sealing ring disposed to sandwich said thermal transfer membrane between said fluid dispersion manifold and said compression/sealing ring.

9. The armor production tool of claim 7, wherein the fluid dispersion manifold is disposed around the perimeter of the thermal transfer membrane and the pressure bearing membrane, and the compression/sealing ring and is disposed around the perimeter of the thermal transfer membrane.

10. The armor production tool of claim 6, wherein the fluid dispersion manifold is in fluid communication with both the fluid dispersion layer and the supply of fluid for introducing one of heated or cooled fluid into the fluid dispersion layer.

11. A method for molding armor using the armor production tool of claim 1, the method comprising:
enclosing a part of armor within a molding chamber defined by the upper molding chamber and the lower molding chamber;
introducing air into at least one of said upper pressure chamber or said lower pressure chamber to apply pressure on said part within the molding chamber;
circulating a heated fluid through the fluid dispersion layer of at least one of the upper thermal diaphragm assembly or the lower thermal diaphragm assembly to apply heat to said part within the molding chamber.

12. A method for producing an armor part, the method comprising:
enclosing a part within a molding chamber of a molding tool, said molding chamber defined by a tool upper part and a tool lower part;
introducing a pressurized gas or fluid into a pressure chamber of at least one of the tool upper part and a tool lower part, wherein said pressure chamber of said at least one of the tool upper part and the tool lower part is separated from said molding chamber by a thermal diaphragm assembly, wherein said thermal diaphragm assembly comprises a thermal transfer membrane proximate the molding chamber, a pressure bearing membrane proximate the pressure chamber of said at least one of the tool upper part and the tool lower part and a fluid dispersion layer disposed between the thermal transfer membrane and the pressure bearing membrane;
circulating one of a heated fluid or a cooled fluid through said fluid dispersion layer of said thermal diaphragm assembly of said at least one of the tool upper part and the tool lower part.

13. The method of claim 12 wherein the introducing a pressurized gas or fluid step further comprises the steps of:
introducing a first pressurized gas or fluid into a first pressure chamber of the tool upper part, wherein said tool upper part comprises a first thermal diaphragm assembly separating said first pressure chamber from said molding chamber; and
introducing a second pressurized gas or fluid into a second pressure chamber of the tool lower part, and said tool lower part comprises a second thermal diaphragm assembly separating said second pressure chamber from said molding chamber.

14. The method of claim 13 wherein said circulating one of a heated fluid or a cooled fluid through said fluid dispersion layer of said thermal diaphragm assembly step comprises:
circulating one of said heated fluid or said cooled fluid through a first fluid dispersion layer of said first thermal diaphragm assembly; and
circulating one of said heated fluid or said cooled fluid through a second fluid dispersion layer of said second thermal diaphragm assembly.

15. The method of claim 14, wherein said introducing a pressurized gas step and said circulating one of a heated fluid or a cooled fluid through said fluid dispersion layer of said thermal diaphragm assembly step occur simultaneously during at least a portion of the duration of molding said part.

16. The method of claim 12 wherein said circulating one of a heated fluid or a cooled fluid through said fluid dispersion layer of said thermal diaphragm assembly step comprises:
circulating one of said heated fluid or said cooled fluid through a first fluid dispersion layer of a first thermal diaphragm assembly of said tool upper part, wherein said first thermal diaphragm assembly separates a first pressure chamber of said tool upper part from said molding chamber; and
circulating one of said heated fluid or said cooled fluid through a second fluid dispersion layer of a second thermal diaphragm assembly of said tool lower part, wherein said second thermal diaphragm assembly separates a second pressure chamber of said tool lower part from said molding chamber.

17. The method of claim 12, wherein said introducing a pressurized gas step and said circulating one of a heated fluid or a cooled fluid through said fluid dispersion layer of said thermal diaphragm assembly step occur simultaneously during at least a portion of the duration of molding said part.
